(19) United States
(12) Patent Application Publication
(10) Pub. No.: US 2026/0033459 A1
(43) Pub. Date: Feb. 5, 2026

(54) LEASH

(71) Applicants: RITA M. VESTER, COCONUT CREEK, FL (US); CSABA VESTER, COCONUT CREEK, FL (US)

(72) Inventors: RITA M. VESTER, COCONUT CREEK, FL (US); CSABA VESTER, COCONUT CREEK, FL (US)

(21) Appl. No.: 19/255,235

(22) Filed: Jun. 30, 2025

Related U.S. Application Data
(60) Provisional application No. 63/677,443, filed on Jul. 31, 2024.

(51) Int. Cl. A01K 27/00

(52) U.S. Cl. CPC A01K 27/003; A01K 27/006; A01K 27/009

(57) ABSTRACT

A leash having an interchangeable platform to display information about an attached pet and/or functional and decorative elements. The leash can be a one-piece leash member which can include a monolithically formed handle portion at one end of an elongated portion and the opposite end of the elongated portion being where a hook, fastener and/or extension member can be secured. At least the elongated portion can be provided with a plurality of holes along its length for attachment of decorative and/or informational pins, using any conventional secure fastening mechanism. The leash can also have an outer reflective or glow-in-the-dark layer or can be constructed from a transparent or translucent material to allow light dispersed within to be visible. A single sided or two-sided decorative element, informational element or functional device can be secured to the leash through the use of one or more holes of the plurality of holes. Preferably, the leash can be constructed through an injection molding process and can be constructed using an Ethylene-vinyl acetate material.

The application claims priority to and the benefit of U.S. Application Ser. No. 63/677,443, filed Jul. 31, 2024, which application is incorporated by reference in its entirety for all purposes.

### FIELD OF THE DISCLOSURE

The disclosure relates generally to leashes preferably for use with animals, such as dogs, but not considered limited to use just with animals.

### BACKGROUND OF THE INVENTION

Traditional pet leashes are used as a means for restraint and control over the animal secured to the leash, such as during a walk. Some conventional leashes also incorporate holders for storing animal waste bags but are otherwise limited in their customization or use for other purposes. Therefore, there remains a need for an animal leash that serves additional functions and purposes from current pet leashes. The disclosed novel pet leash is directed to providing such an improved animal leash.

### SUMMARY OF THE INVENTION

A novel leash (which, without limitation, can be a pet leash) is described and which can provide for a customizable and interchangeable platform to display various attributes preferably concerning the animal attached to the pet leash. This provides for enhanced communication, social interaction and engagement among dog owners and passersby individuals and can inform such passerby of the demeanor of the animal while the passerby is at a safe distance from the animal.

In a first non-limiting embodiment, the novel pet or animal leash can be provided as a one-piece leash member which can include the handle portion and the opposite end where a hook or other fastener can be provided, such as, but not limited to, connecting to a collar or harness being worn by the animal. Preferably, the novel leash can be used in connection with dogs, but such is not considered limiting, and the novel animal leash is not considered limited to any specific animal and can also be used for human use which is also considered within the scope of the disclosure. However, for the non-limiting examples of use, use of the leash with a dog will be used.

Preferably, the body member can serve as a flexible lead (based on material selected) and can be provided with a plurality of holes along its length between the handle area and hook attachment area. The plurality of holes can accommodate the attachment of decorative and/or informational pins, using any conventional secure fastening mechanism. Though the pins can be decorative and can also be provided with a light, flashing light and/or strobe light (to aid in visibility of the animal and user during nighttime conditions, the pins also can also be used in addition or alternatively to convey specific information about the dog being walked. As non-limiting examples, information can be provided on the pins concerning, the dog's gender, temperament, age, and/or special skills. As noted above, alternatively or additionally to informational pins, pins can be secured to the leash for adding decorations not specific to the dog. A mixture of uses for the pins can also be used at the same time given the preferably plurality of holes provided on the leash for securing pins. As a non-limiting example, a one or more pins may be secured to the leashes including symbols or icons indicating gender, temperament, and/or age, and at the same time one or more customizable pins may also be secured to the leash which feature text or graphics representing specific skills for the dog and one or more pins could also be provided on the leash that are merely decorative and not specific to the dog.

Accordingly, the novel leash disclosed herein allows a pet owner to convey specific information about their pets to passersby individuals, preferably while the individual(s) are at a safe distance from the pet (in the event the pet is not friendly). The novel leash provides a customizable platform for displaying various attributes and characteristics of the dog being walked, therefore fostering communication and social interaction between owners and passersby individuals.

Other novel features can be provided for the leash and can include one or more of the following: (1) the leash can be manufacturing through use of molding manufacturing techniques; (2) the molded leash can be provided with a connection feature at its terminal (non-handle) end; (3)

### BRIEF DESCRIPTION OF DRAWINGS

FIG. 1 is a perspective view of a first, non-limiting, embodiment for the novel animal, one-piece leash in accordance with the present disclosure;

FIG. 2 is top view of the embodiment of FIG. 1 with a non-limiting hook/fastener secured at the non-handle end of the leash in accordance with the present disclosure;

FIG. 3 is a perspective view of slight variation for the first embodiment of FIG. 1;

FIG. 4 is a perspective view of another variation of the first embodiment of FIG. 1 wherein the leash is provided with one or more mounds/humps near the hook end and/or near the handle end and can be provided with ornamental features in accordance with the present disclosure;

FIG. 5 is a perspective view of the variation seen in FIG. 4 with a plurality of non-limiting pins secured within a few of the provided holes in the leash in accordance with the present disclosure;

FIG. 6 is a top view of the leash with non-limiting secured pins seen in FIG. 5;

FIG. 7 is a top exploded view of a second, non-limiting, embodiment for the novel multiple piece animal leash in accordance with the present disclosure;

FIG. 8 is a top assembled view of the second embodiment shown in FIG. 7 for a multiple piece animal leash;

FIG. 9 is a side view of the assembled embodiment shown in FIG. 8;

FIG. 10 is a top view of a third, non-limiting, embodiment for the novel animal leash having an internal wire running around at least a portion of the perimeter in accordance with the present disclosure;

FIG. 11 is a perspective view of the embodiment of the leash shown in FIG. 10;

FIG. 12 is a sectional view of the embodiment shown in FIG. 10 where the internal wire is visible;

FIG. 13A and FIG. 13B illustrate a non-limiting hook (i.e. swivel hook, etc.) that can be secured to the non-handle end of the leash and in one non-limiting embodiment can have a U-shaped fork-style swivel snap hook examples for terminal connection;

FIG. 13C through FIG. 13G illustrate non-limiting embodiments for the non-handle end of the novel leash and showing a hook mount and hole (with variations) in accordance with the current disclosure;

FIG. 14A through 14H and FIG. 14J illustrate non-limiting embodiments for a middle or intermediate section of the novel leash and showing a preferred one or more attachment holes which can be used for securing a bag holder, light, or other objects or items and showing several different items attached to the middle or handle areas of the novel leash and non-limiting attachments methods in accordance with the present disclosure;

FIG. 14K through FIG. 14S illustrate a non-limiting collection or non-limiting samples of ornaments, accessories or other items that can be attached or secured with the holes or openings provided in the novel leash in accordance with the present disclosure; FIG. 15 illustrates an embodiment of the novel leash in use with a harness or backpack (i.e. non limiting tethering examples), such as, but not limited to, a child size harness or backpack;

FIG. 16A illustrates a non-limiting extension member/system which can be secured to the novel leash, which can be, without limitation, a cable, wire, cord or rope extension member and can be of any length, and in one non-limiting embodiment, can be 25 feet in length;

FIG. 16B and FIG. 16C illustrate embodiments of the novel leash shown with a static or rope-based leash (FIG. 16B) or retractable (FIG. 16C) extension member secured;

FIG. 17A and FIG. 17B illustrate an embodiment of the novel leash wherein at least a portion of the leash can be transparent such that light from attached lights, which can be LED modules installed in one or more holes of the leash, can be seen dispersed through the interior of the leash (FIG. 17B internal illumination effect and hole diffusion seen);

FIG. 18 illustrates at least a partially and preferably a fully reflective and/or glow- in-the-dark coating leash embodiment preferably provided through a coating having such characteristic(s);

FIG. 19A through FIG. 19E illustrate non-limiting leash body shapes, with and without molded handles, for the novel leash;

FIG. 20A through FIG. 20D illustrate a non-limiting handle embodiment and a snap hook member that can be secured to the novel leash, such as, without limitation, by rivets or screws;

FIG. 21 illustrates a non-limiting NFT chip embedded location and a non-limiting verification user interface (“UI”) that can be used or provided with or integrated with the novel leash;

FIG. 22 illustrates a non-limiting molded tracking pocket and non-limiting tracker placement location on the novel leash and/or a harness;

FIG. 23A illustrates a single-sided decorative element attachment secured in one non-limiting embodiment via a recessed backplate; and

FIG. 23B illustrates a double-sided decorative element attachment secured in one non-limiting embodiment via a screw or snap-fit connection.

### DETAILED DESCRIPTION OF THE INVENTION

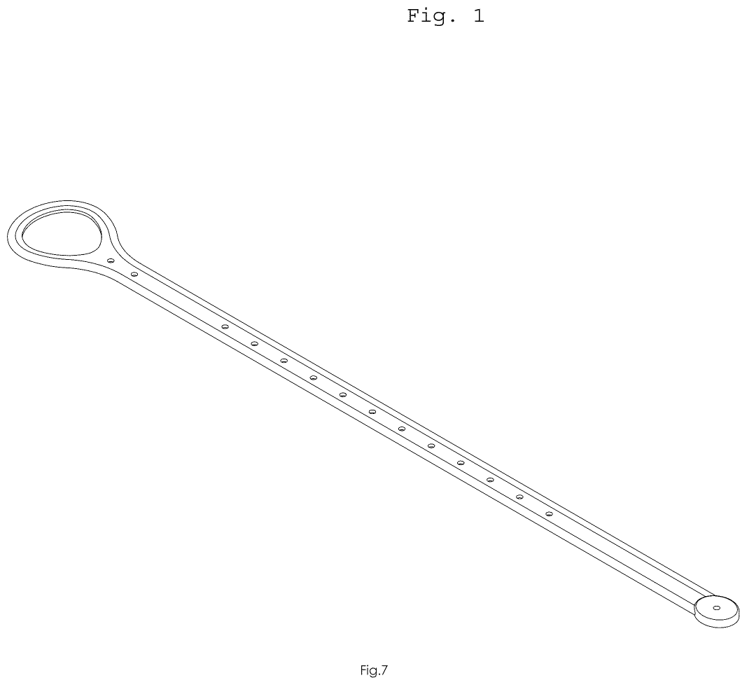

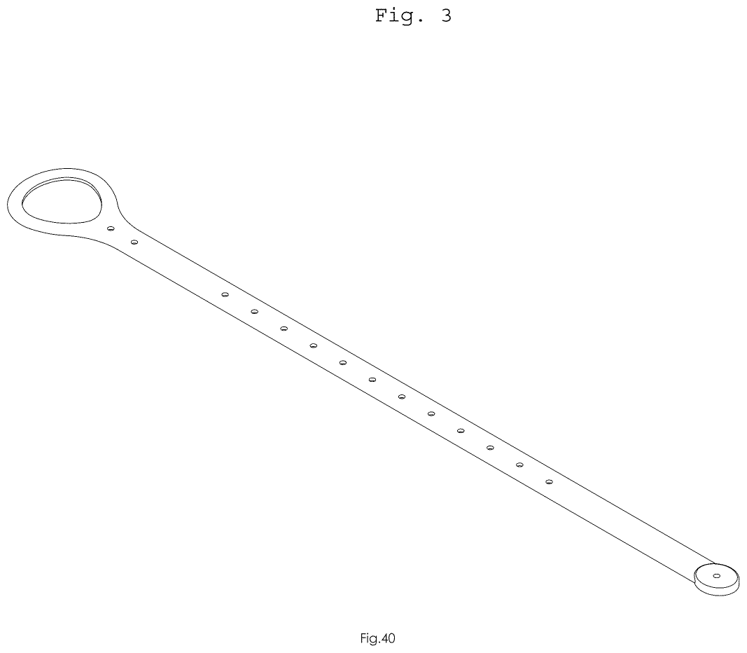

FIGS. 1-6 illustrate several non-limiting variations for a first embodiment for the novel animal leash. As seen, in this embodiment the leash can be preferably one-piece including its handle area and the opposite end where a hook member is fastened. The leash can be monolithically formed or constructed integral as a one-piece leash. Preferably, the one-piece leash can be a molded handle and leash embodiment.

In a preferred embodiment, the leash can be constructed using a material or combination of materials that is (are) similar to or the same as the material(s) used for constructing CROCS shoes. Accordingly, the leash can be constructed from a polyethylene vinyl acetate material, foam resin material. Foam material, resin material, rubber material and/or polymer material or combinations thereof, that provides for a flexible leash. However, the leash is not considered limited to any specific materials and other materials or combination of materials can be used for constructing the novel leash and are considered within the scope of the disclosure.

As seen in FIG. 1 through FIG. 4 an integrated single-piece handle and body/elongated portion design can be provided, such that a single-piece novel leash (i.e. body and handle) can be provided which can allow for greater strength, reduced failure points and streamlined manufacturing. Thus, the novel leach, in one non-limiting embodiment, can be provided with uninterrupted construction for strength and durability.

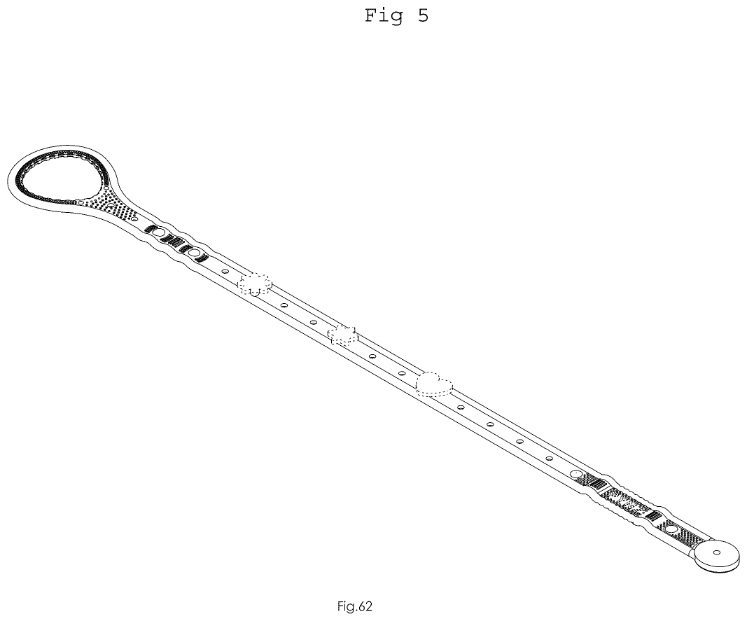

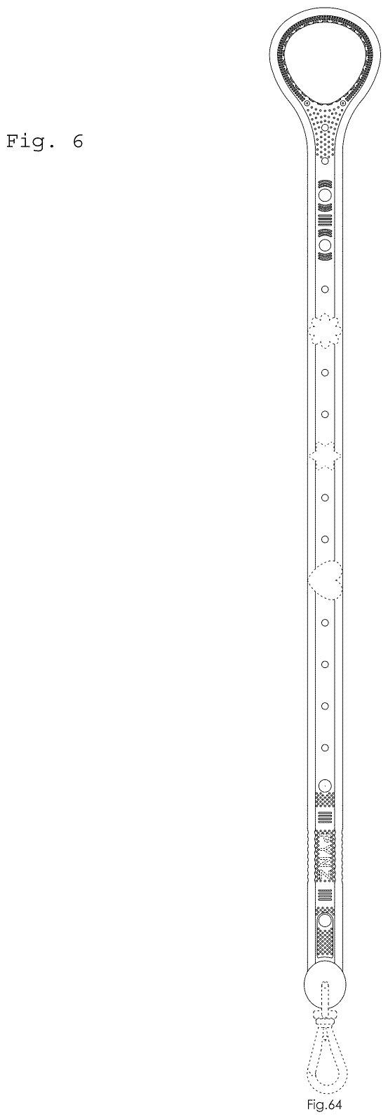

A plurality of holes can be provided in the central part of the leash for hosting or otherwise securing one or more pins to the leash for making fun, fashionable and personalized statement and/or providing information concerning the animal secured to the leash (See FIG. 5 and FIG. 6). Though not preferred, one or more pins containing information about the user of the leash can also be provided (e.g. health condition, the user is deaf, etc.) and also considered within the scope of the disclosure. Accordingly, the pins can be, but are not limited to, symbols, icons, words, a phone number, emergency contact information, etc. or any combination of the above.

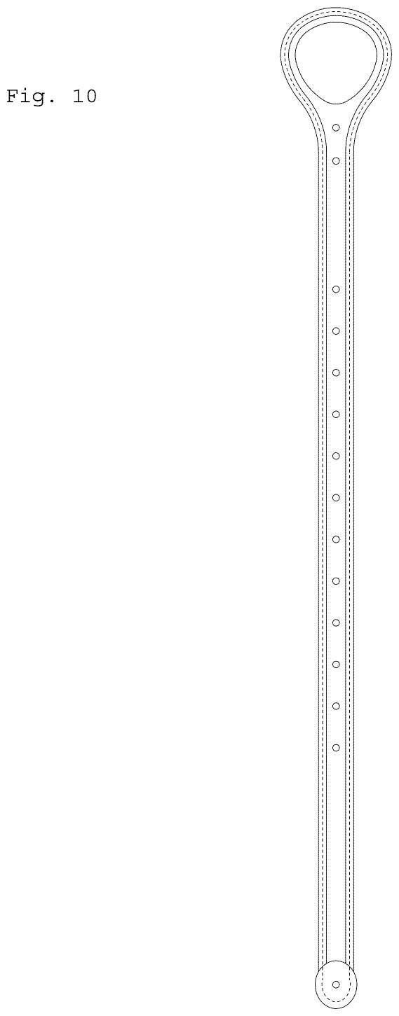

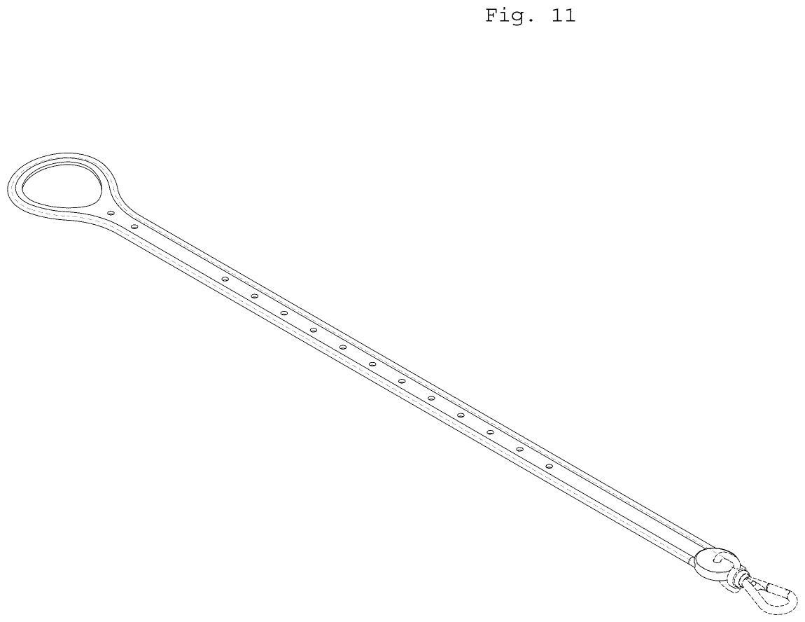

Though not considered limiting, preferably, the leash can be constructed preferably using injection mold and Ethylene-vinyl acetate (“EVA”) or similar material. Other construction techniques and/or materials can also be used and are considered within the scope of the disclosure. Preferably, a continuous one-piece leash is created with or without an internal metal line or wire inside (See FIG. 1-FIG. 6 for without an internal metal line or wire and See. FIG. 10-FIG. 12 for with an internal metal line or wire) (for the provisional utility patent). As noted below in the discussion for FIG. 10-FIG. 12, the metal line or wire can run through the entire leash to increase the strength of the leash, such as, though not limiting, for use with large dogs. However, it is also within the scope of the disclosure that the leash can be used with large dogs and/or other large animals also without an internal metal line or wire.

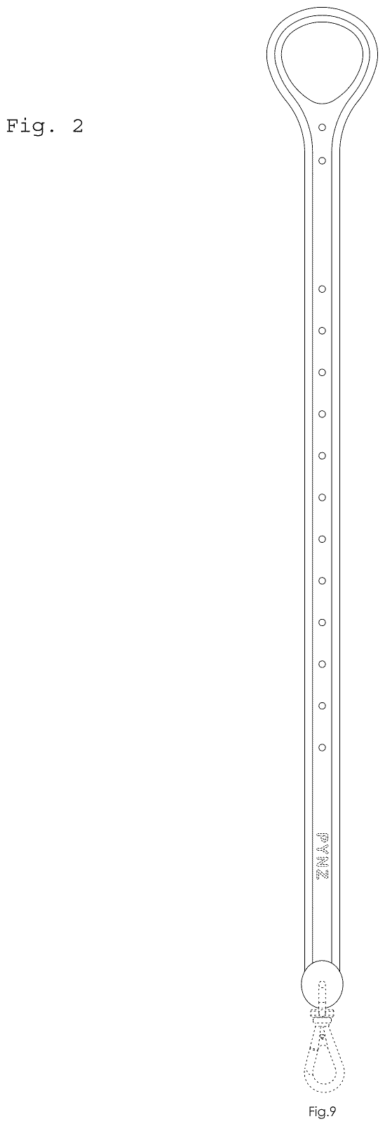

The dog's collar and/or harness can be attached to the leash with a round swivel eye bolt snap or hook (see FIG. 2) which is not considered limiting and other attachment mechanisms for securing the leash to the collar and/or harness or other article or item being worn by the dog or animal can also be used and are also considered within the scope of the disclosure.

The preferred, non-limiting, swivel snap hook, carabiner or the like (collectively “swivel snap”), can be placed in the hole at the end of the leash (i.e. secured to the leash) after the manufacturing of the leash. However, the swivel snap can also be added during manufacturing and the placement of the hook becomes part of the manufacturing process and is added during the injection process.

As noted above, a primary, though not limiting use for the leash (in all embodiments) is for use as a conventional leash to walk a dog. However, unlike conventional leashes, the described novel leash provides other benefits and advantages which include, without limitation, the use of a plurality of holes on the leash body for the receipt of decorative and/or informational pins, as well as providing for securement locations for other items as well. Accordingly, the user can customize their leash to their specific liking or needs. Below is one non-limiting “use” example, to illustrate the functionality of the disclosed novel leash (in all embodiments):

A dog owner is walking their one-year-old female dog, who has recently mastered the skill of sitting on command. By attaching a 1-year-old birthday cake pin to the leash, a pink pin indicating or representing the dog's gender, a green pin signifying or representing friendliness, and an “I CAN SIT” pin showcasing the dog's training achievement. The owner/user can proudly, immediately and effectively communicate this information. As a result, by displaying these accessories people will know they are welcome to approach the dog or puppy, they can automatically refer to the dog as a girl, inquire about the dog's birthday, and congratulate the dog on her sitting achievement, thus enhancing public awareness, social interaction and fostering a sense of community among dog enthusiasts.

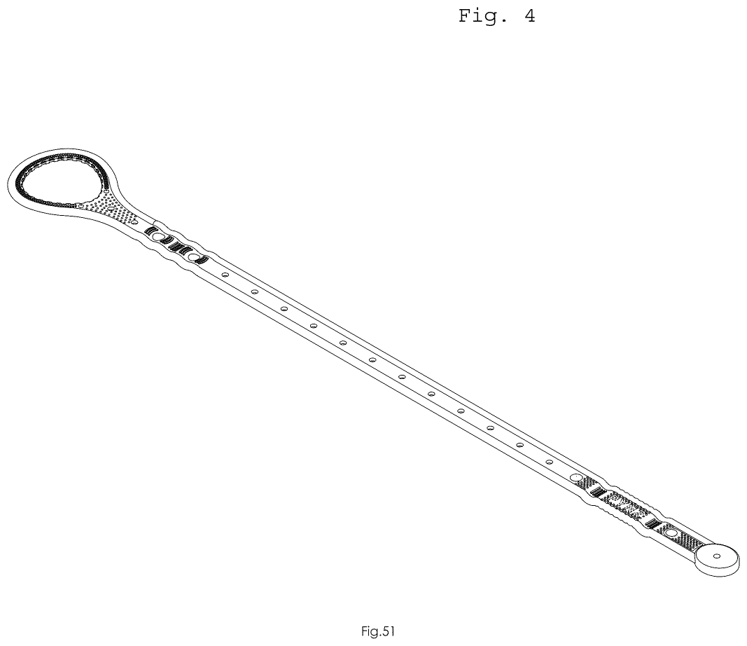

As best seen in FIG. 4 and FIG. 5, one or more mounds, humps, etc. (collectively “humps”) can be provided on the body member of the leash near the handle area and/or near the swivel snap attachment area. Though the humps are optional, when provided, in addition to primarily contributing to the decoration and design of the leash.

Other optional bumps can be provided around the handle area where the user preferably holds the leash and while also providing a decorative element, may also aid in enhancing the user's grip, comfort, and control.

For improved grip, increased friction can be provided, as a textured surface can be created by the bumps at the handle to increase friction between the handle and the user's hand, making it less likely to slip, especially in wet or sweaty conditions. The bumps can also provide for a more secure grip, which can reduce the chance of the leash slipping from the user's hand, especially where the leash is being used to handle strong or energetic dogs.

Comfort for the user can also be enhanced through an ergonomic design for the handle area. The bumps can be placed to fit the natural contours of the hand, distributing pressure more evenly and reducing strain during long walks, which may aid in making it easier to maintain a firm grip without exerting too much effort.

Control of the dog or animal attached to the leash can be improved through a secure and comfortable grip. This can allow for better control over the dog or animal, thus also contributing to the dog's safety and behavior.

Accidents and enhanced safety can also be provided by providing for a firm grip, which can aid in reducing the likelihood of the leash being accidentally dropped during a situation or otherwise. The firm grip strength also allows the dog or animal to be controlled more effectively, thus reducing the risk of the dog pulling away.

As noted above, the leash can be manufactured in one non-limiting embodiment using injection molding and preferably with whole leash being one piece without or with the metal wire or line. One non-limiting alternative manufacturing technique can also be 3D printing.

Where injection molding is selected for manufacturing the novel leash, the following general steps can be performed (described with the metal wire being included):
1. Design the Mold: The injection mold can be designed to accommodate the metal insert (where the metal wire/line is included), which can include ensuring/confirming that the mold bas cavities to securely hold the metal strip in place during the injection process.
2. Insert Placement: Manually or automatically place the cleaned and treated metal wire into the mold cavity and ensuring/confirming that the metal wire is securely positioned and aligned correctly.
3. Securing the Insert: The mold can have features to hold the metal wire in place, such as clips, pins, magnets, etc.
4. Close Mold: Close the mold securely, ensuring/confirming the metal wire remains in place.
5. Inject Plastic: Inject the molten plastic into the mold cavity. The plastic can flow around the metal wire, encapsulating it within the plastic part.
6. Cooling: Allow the plastic to cool and solidify within the mold. The cooling time can depend on the type of plastic and the size of the part.
7. Open Mold: Once the part has cooled, open the mold.
8. Eject Part: Eject the molded part from the mold cavity. The metal strip can preferably be securely encapsulated within the plastic part.

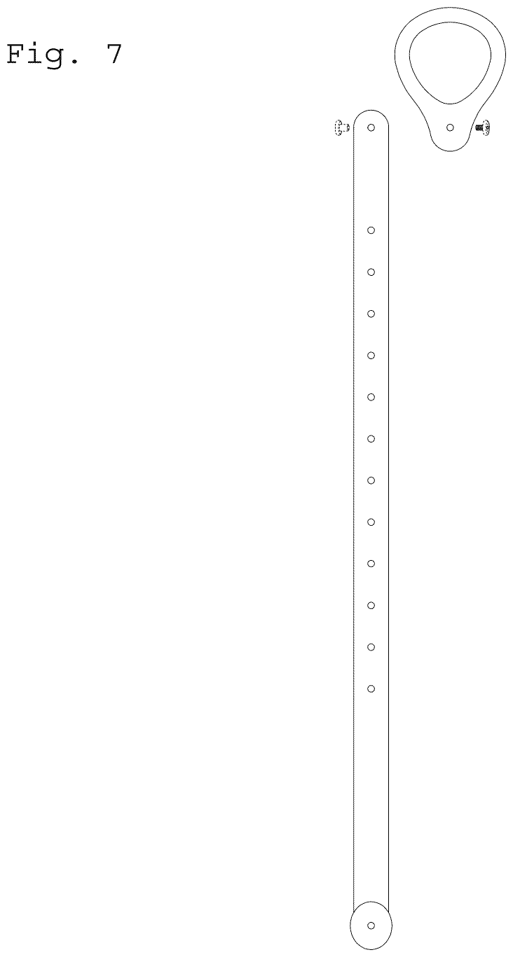

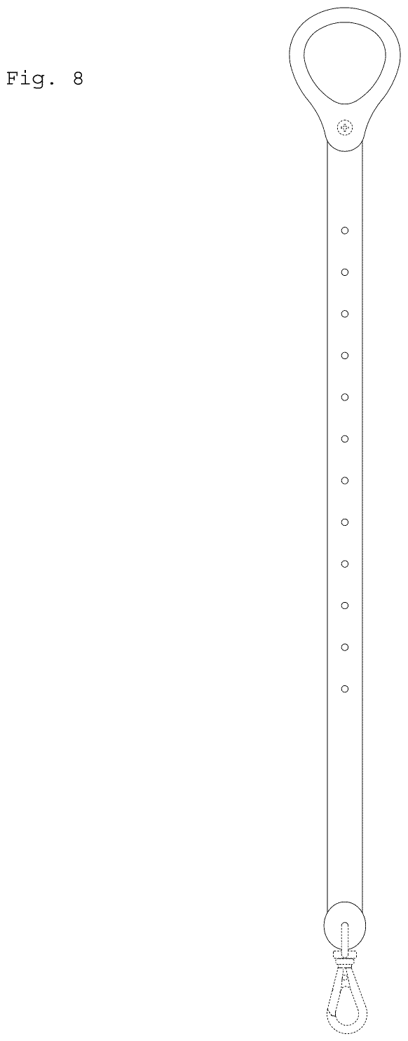

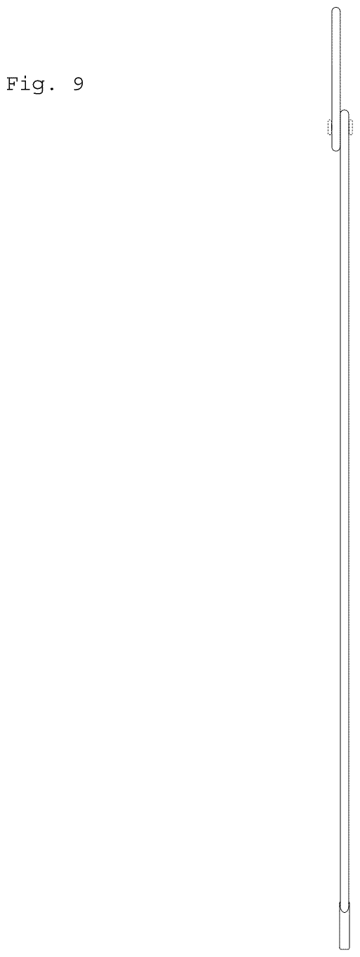

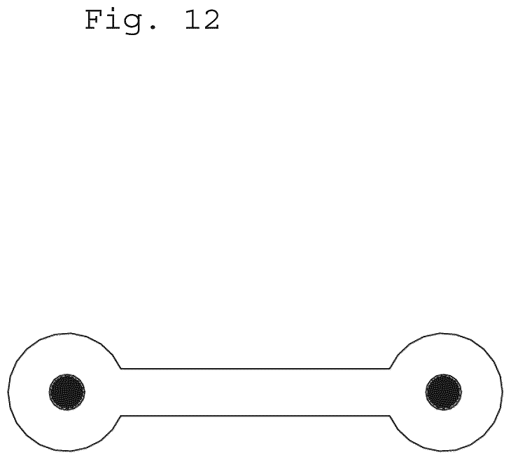

FIG. 10-FIG. 12 illustrate the one-piece embodiment where the wire or line (preferably metal wire or line—though not limiting) can be disposed around the edge/perimeter of the leash. FIG. 12 shows a sectional view of the leash where the preferred internal wire (shown as the two dark circles in FIG. 12) can be seen. It should be noted that in the two-piece leash embodiment of FIG. 7-FIG. 9, the metal wire can be provided in the body member piece and/or the handle and where in both pieces two separate metal wires can be used.

FIG. 12 illustrates a preferred, non-limiting internal position for the wire with respect to the body of the leash. The internal wire preferably can make the leash stronger and can be able to bend or be as flexible as the remaining portion of the leash that it is enclosed within. The internal wire can help with load distribution, as the wire can help to distribute the load more evenly across the material of the leash body (e.g. EVA, tec.). Thus, any stress applied to the material of the leash can be partially taken up by the wire, reducing the stress on the leash itself.

The use of the internal wire can also help to increase tensile strength, as the wire increases the overall tensile strength of the leash. Tensile strength can be the resistance of a material to breaking under tension. As the wire can handle greater tensile loads without deforming, it can enhance the strength of the leash and may have more significance when the leash is being used for large dogs or other stronger animals. The presence of the wire can also enhance the durability of the leash and makes the leash more durable. Under repeated stress and strain the leash may eventually degrade over time. The incorporation of the internal wire can help to maintain the structural integrity of the leash over a longer period. Preferably, in the one-piece leash embodiments, the internal wire is a one-piece continuous wire, though such is not considered limiting.

In one non-limiting example for producing the leash with the wire, the chosen leash material can be partially poured in the mold and allowed to at least partially hardened, and the wire then placed on top of the partially hardened material and the remaining material poured.

In another non-limiting embodiment, the leash may be manufactured using solid molding, such as, but not limited to, solid compression molding or non-foamed thermoplastic elastomer molding techniques. In this process, the metal wire can be pre-positioned in the mold cavity, and the solid leash material can be molded around it in a single-stage or multi-stage molding operation. This method similarly allows for secure encapsulation of the metal wire within the leash body, and can produce equivalent structural, functional, and durability benefits as described above.

FIG. 7-FIG. 9 illustrate a two-piece embodiment for the leash, where the handle and the remaining portion of the leash body member can be separate pieces that are fastened or otherwise secured together to form the functional leash. Various types of fasteners for securing/attaching the two pieces together can be used and all are considered with the scope of the disclosure.

In one non-limiting embodiment, the handle can connect to the leash strip with a flat head or Phillips head screw, which can be flat on both sides. In this embodiment, one screw can be male, and the other can be female (See FIG. 7), and the screws can be inserted through aligned openings in the handle and an end of the remaining leash body, and the two screws tightened together. Preferably, the fastener selected for securing the handle to the remaining leash body can be strong enough to withstand pulling on the leash by the dog or other animal. Other non-limiting examples of fasteners that can be used include screws, swivel hardware, durable snap assembly (that can have one piece preferably permanently secured to the handle and the other piece of the snap assembly preferably permanently secured to the end of the remaining leash body).

By providing for a separate handle in certain embodiments, the user can change the handle color, style, shape, etc. to allow for further personalization or customization of the leash. Where a swivel hardware connection is used, the user of the leash can be provided with more flexibility when the dog or other animal is active on the leash. The swivel hardware allows the user to keep their hand in the same position, while the movement of the swivel hardware accounts for the movement created by the active dog or other animal.

The two-piece leash can also be made with injection molding, 3D printing or other manufacturing techniques. Where injection molding is used, the two pieces can be produced in the same or separate molds. As with the one-piece embodiment, the two-piece leash can be made from EVA or other materials, which can also include, without limitation, leather or polyester and all types of materials are considered within the scope of the disclosure.

The handle and remaining leash body (i.e. strip) can also be pre-manufactured material sheets such as, without limitation, using a die-cut method. The die-cut method can be used for producing the one-piece leash embodiments.

Preferably, the swivel snap can be added to the leash after manufacturing by attaching it to the hole at the bottom (i.e. end opposite of the handle) of the leash. Alternatively, the swivel snap can be integrated into the leash during the injection molding process, which could require further additional design/engineering for the mold.

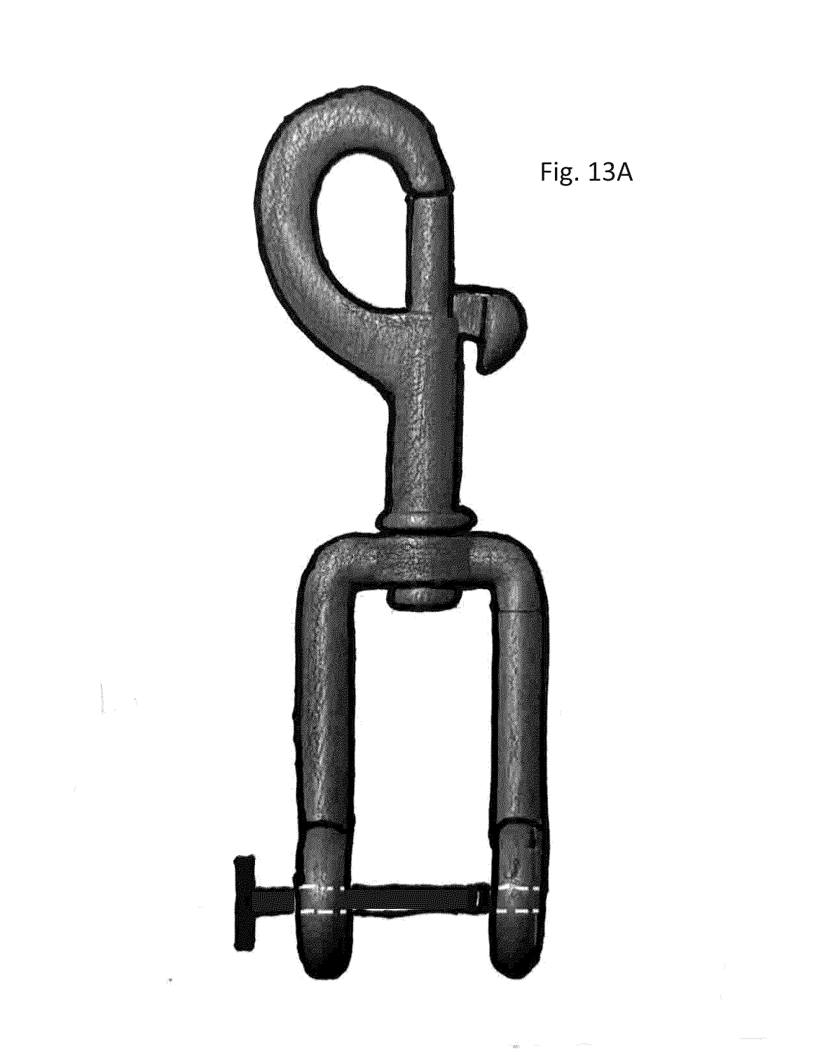

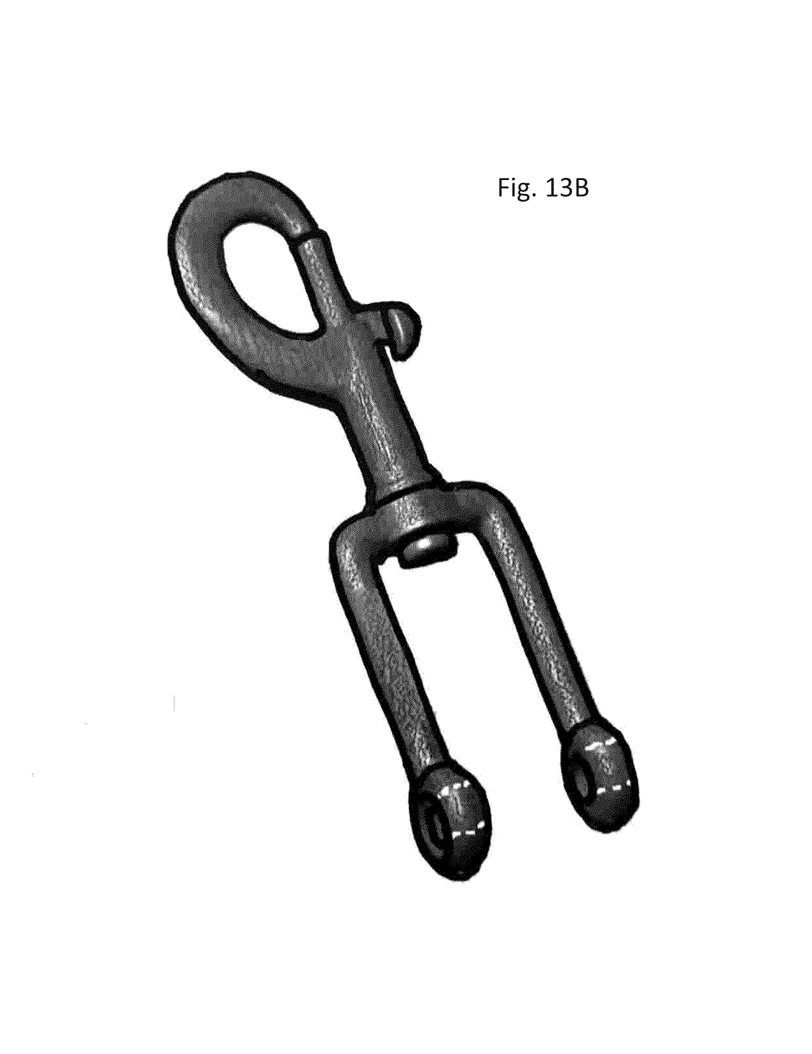

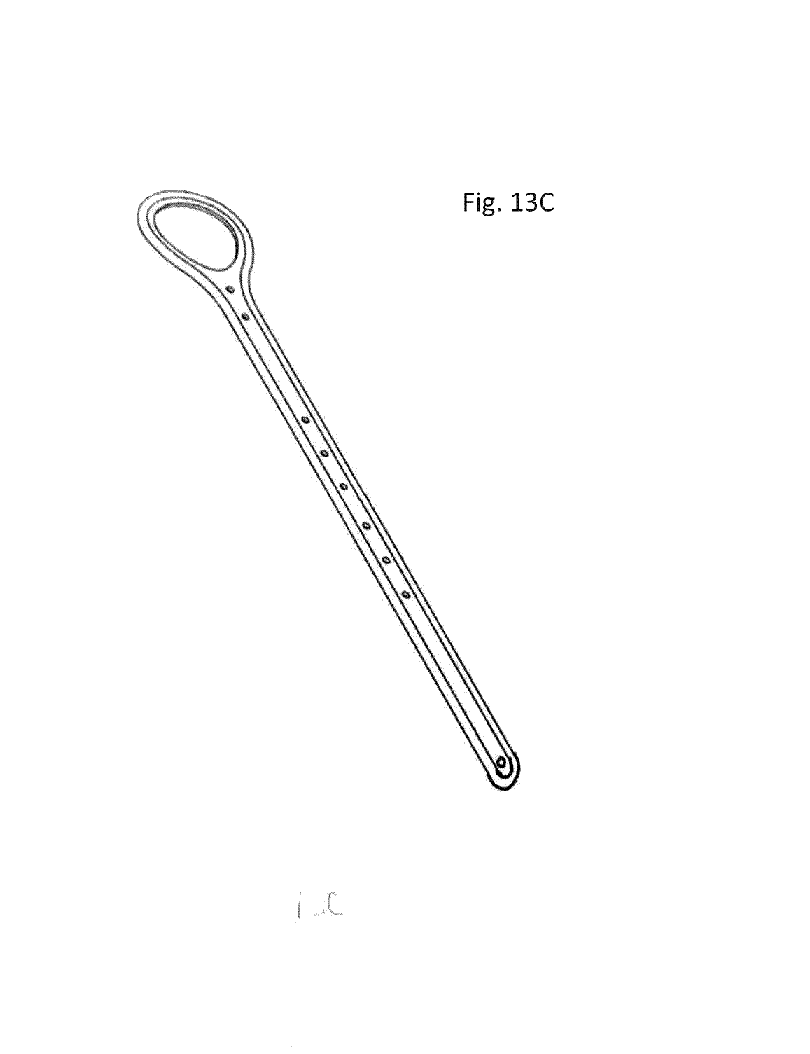

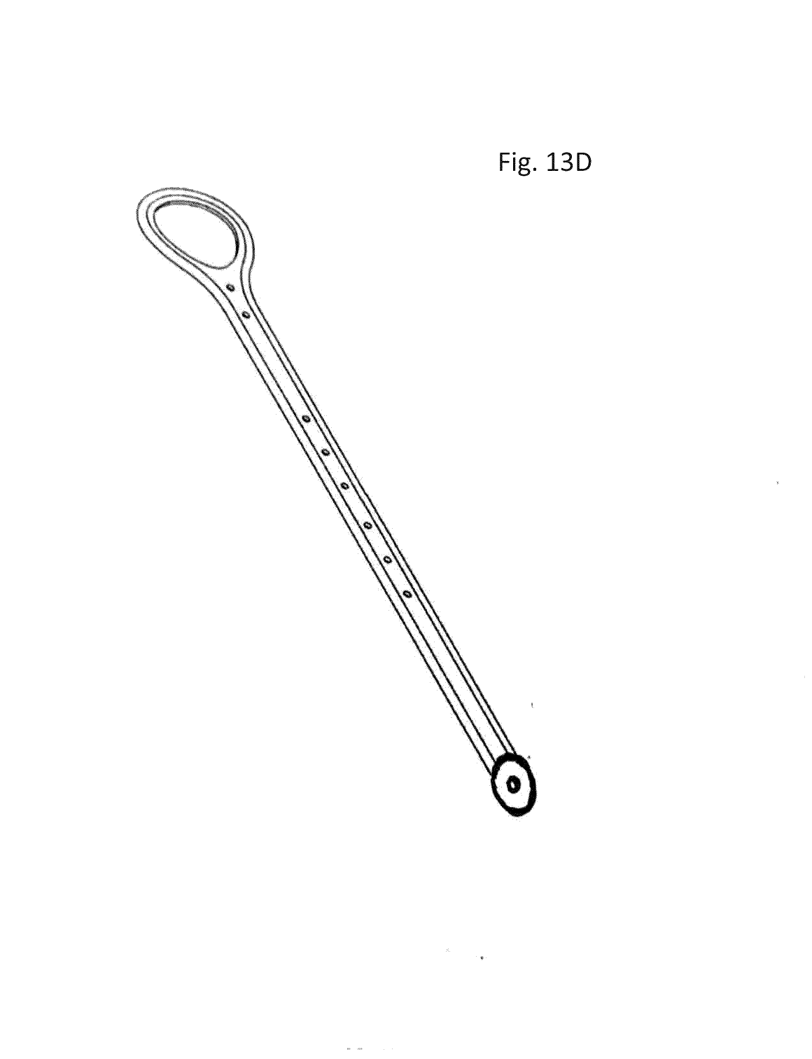

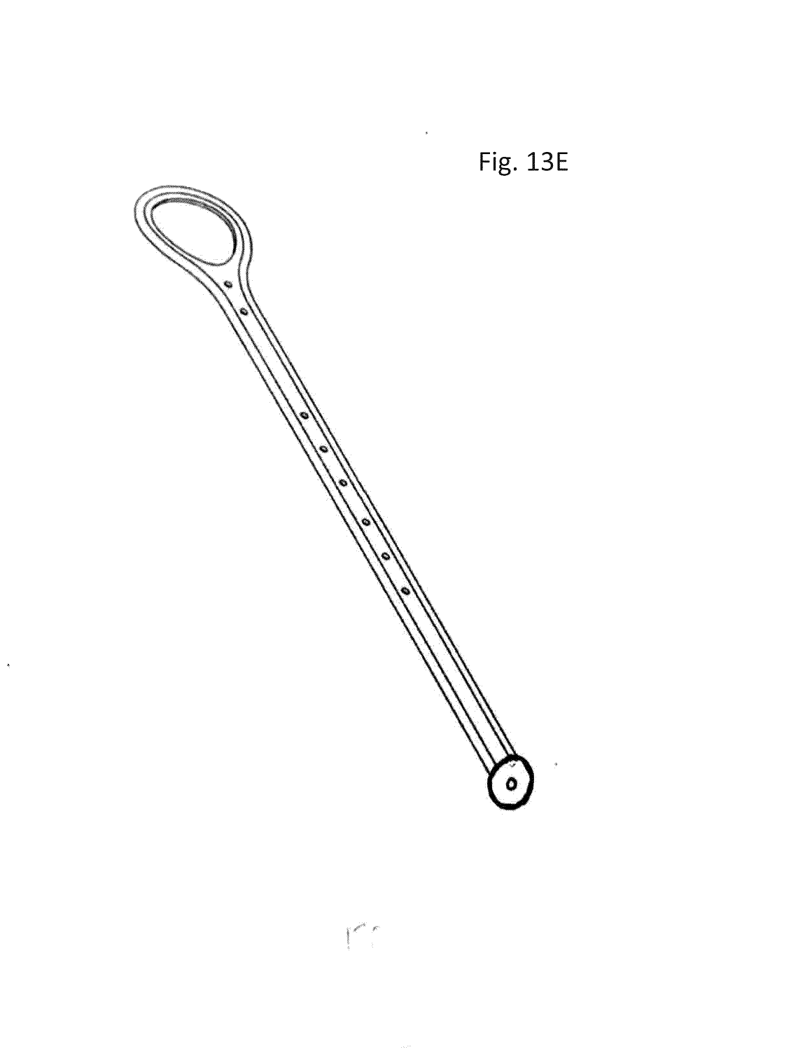

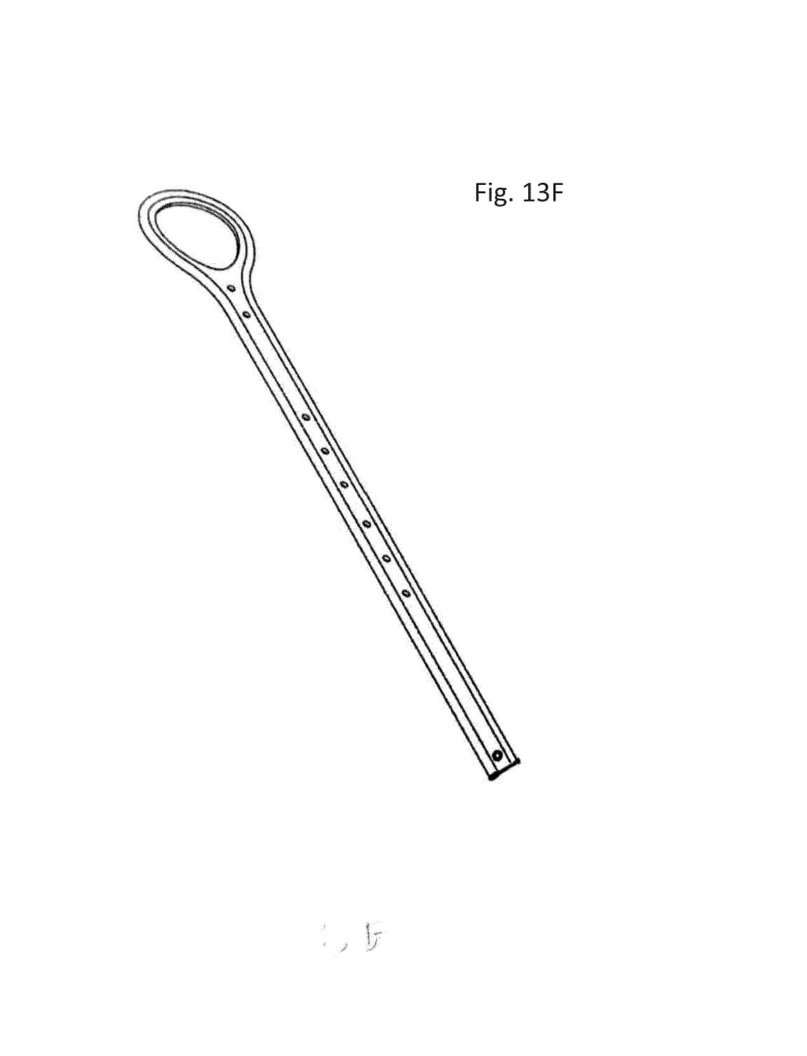

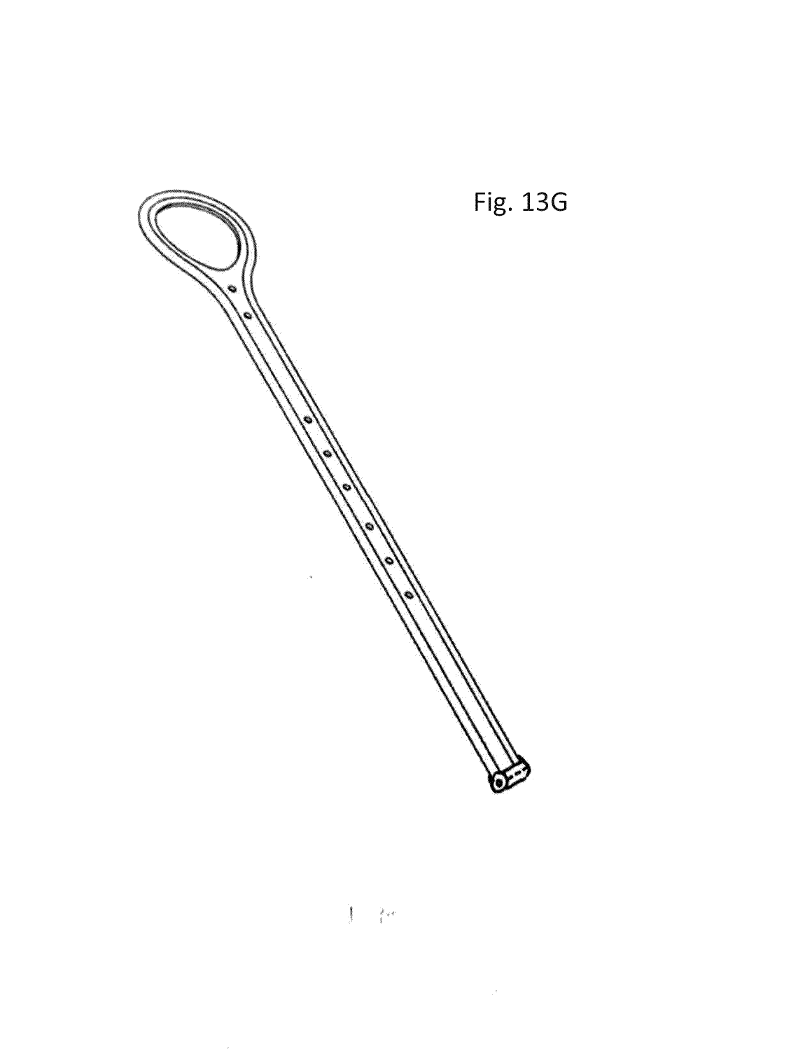

The novel leash embodiments disclosed and described herein can be provided with a hook member and/or snap hook, which can be preferably integrated. The molded leash can include a connection feature preferably at its terminal end (i.e. non-handle end) for securing a snap hook or similar fastener. A bulged or contoured portion or area can be provided at or near the terminal end and preferably provided with a hole or other opening to accommodate various connection hardware, including but not limited to, U-shaped fork-style swivel snap hooks (FIG. 13A and FIG. 13B); Carabiner-style snap hooks; as well as other fastener systems.

The hole/opening geometry is not limited to any particular shape and can be, without limitation, rounded (FIG. 13C), oval (FIG. 13D), circular (FIG. 13E), and/or straight-ended (FIG. 13F). The hole/opening can be preferably integrated into a reinforced bulge (FIG. 13G)/contoured portion or at a flat end portion and can be designed to provide controlled tensile strength. As the hole/opening geometry is not limited to any specific shape, it can be customized to meet different strength or accessory requirements as needed.

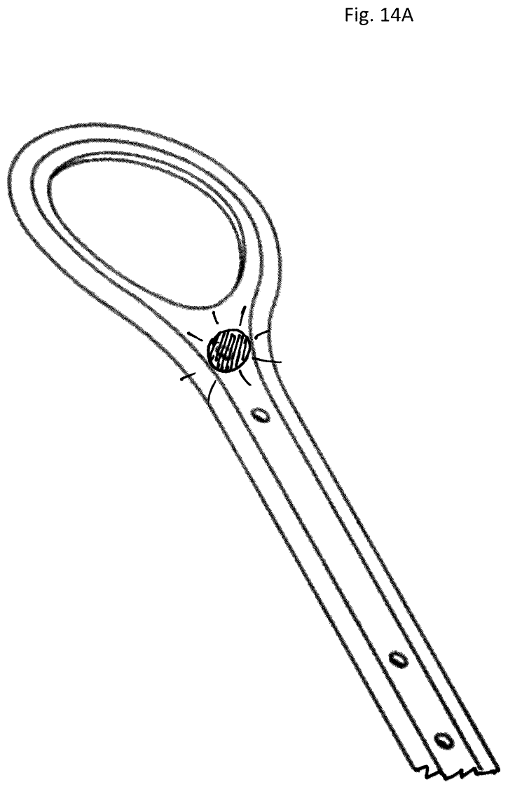

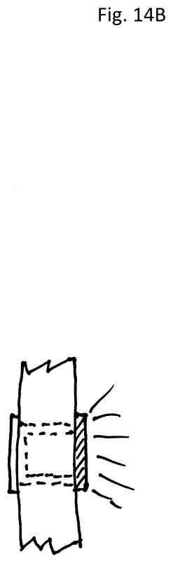

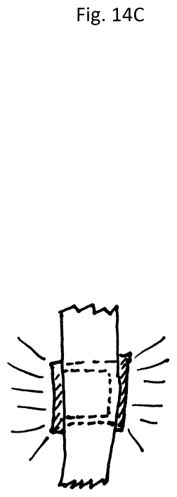

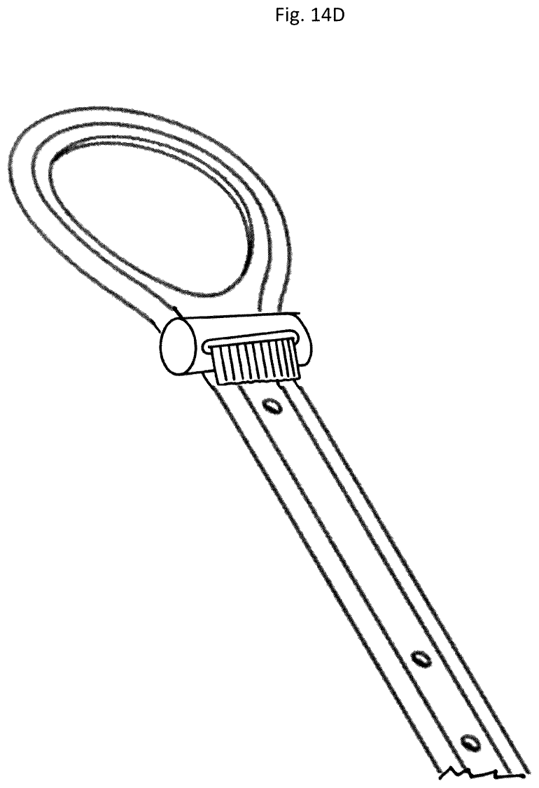

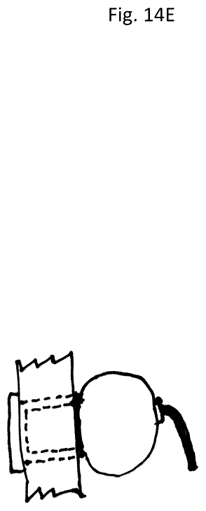

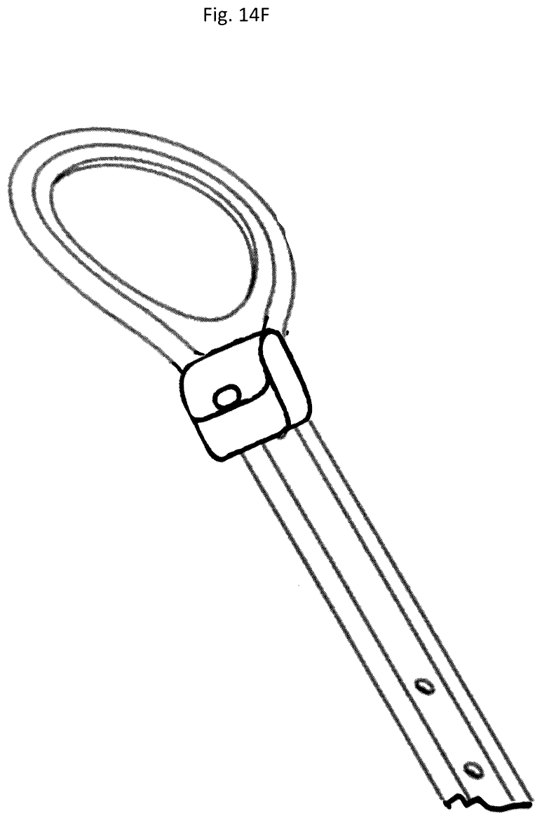

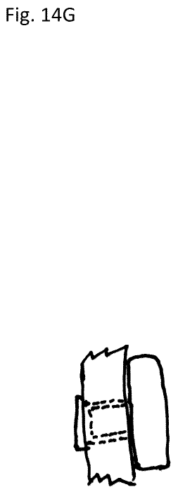

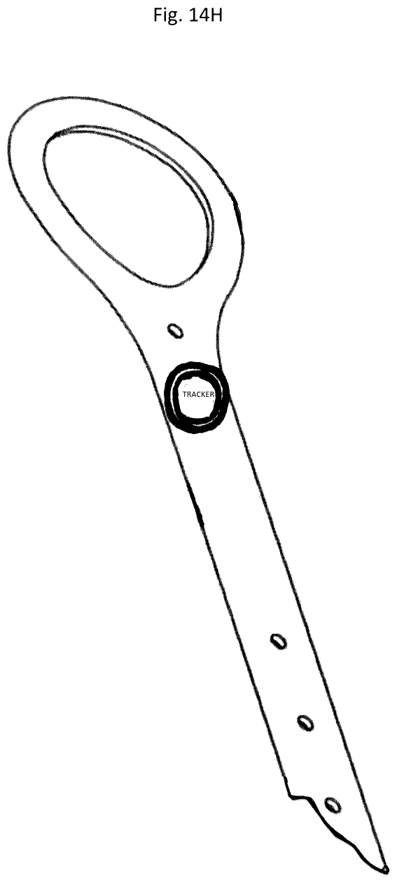

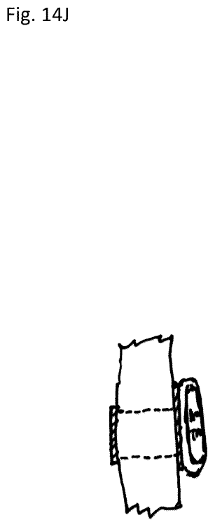

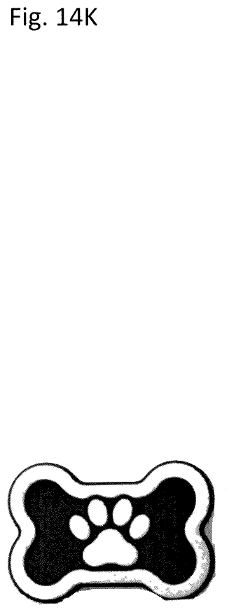

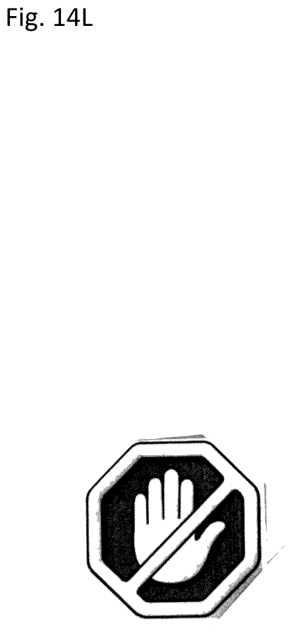

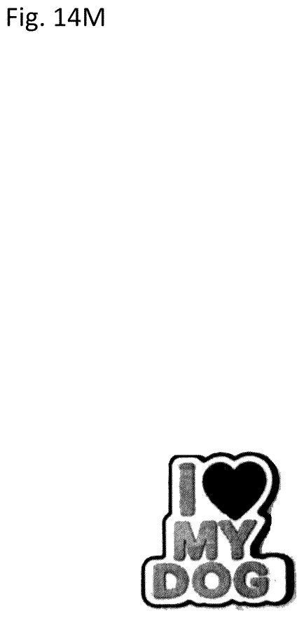

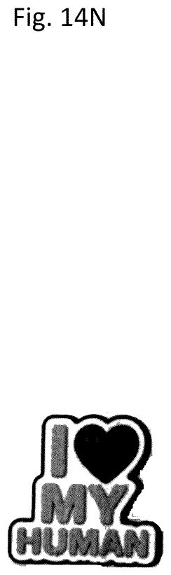

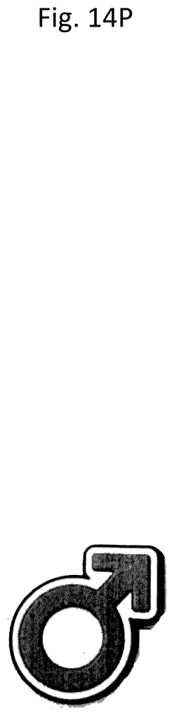

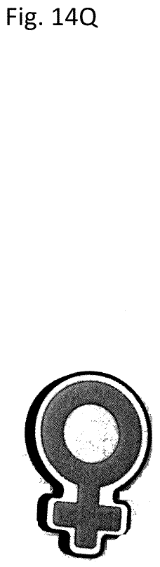

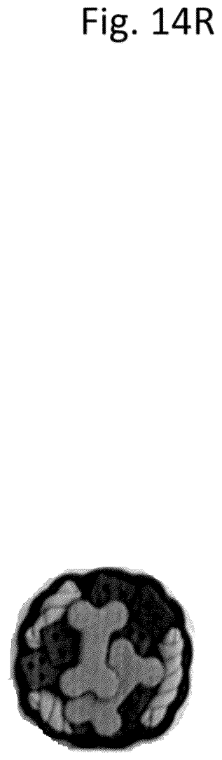

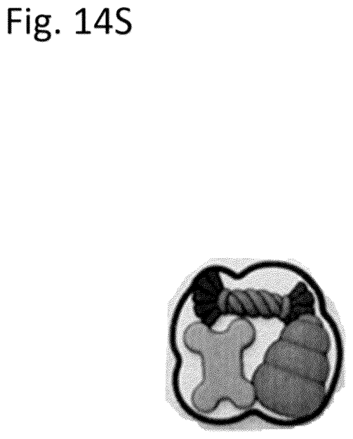

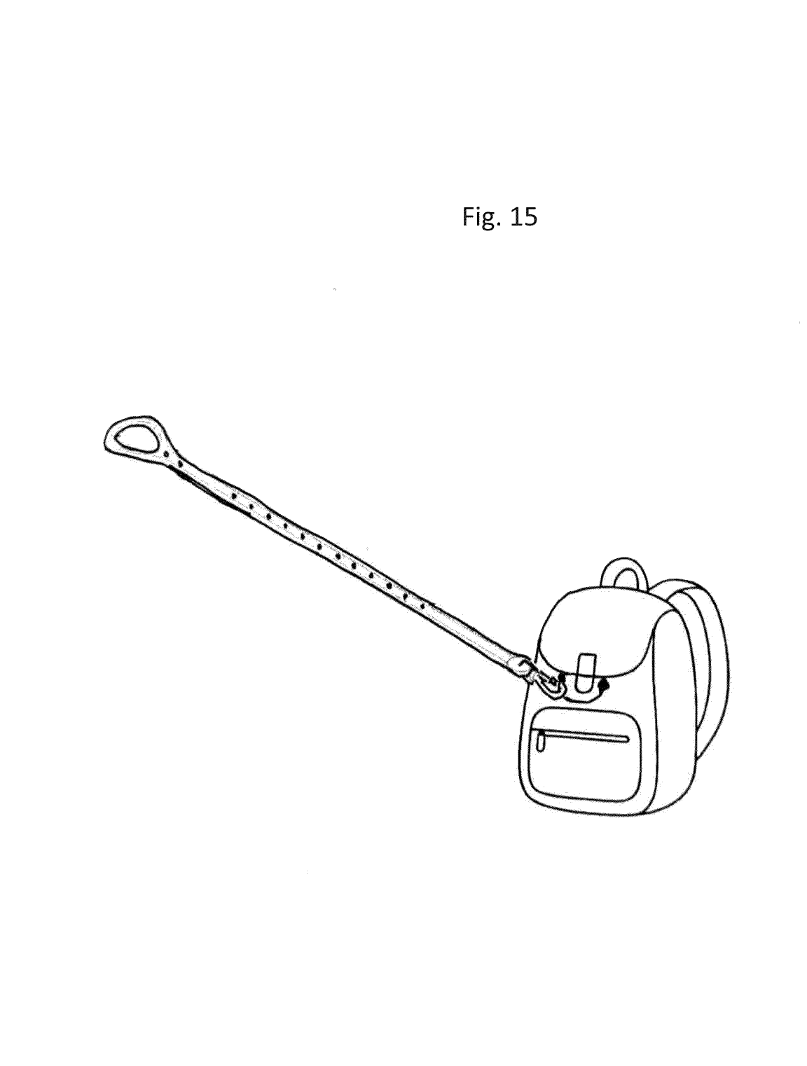

As seen in FIGS. 14A through FIG. 14H and FIG. 14J, the leash can be provided with openings (i.e. utility openings in the middle/intermediate and handle sections) for receipt and preferably removable attachment of one or more accessories, such as, but not limited to, lights, LED clip-on lights. LED lights, clip-on lights, waste bag dispensers, treat bags, airtage/keychain holder, general accessory/item holder, etc. The openings can be molded holes or slots that are created through the novel molding process for forming the preferred one-piece leash (combined handle and elongated portion) or two-piece leash (separate handle and elongated portion secured together by any known or later development securement mechanism). The openings can be functionally integrated into the leash body for multi-use convenience.

Accordingly, the novel leash's middle and handle sections can include molded holes, openings and/or slots that allow users to attach a variety of accessories, such as: (a) LED clip-on lights mounted on the leash (FIG. 14A), which can contain a novel single-sided securing method (FIG. 14B) and/or a double-sided securing method (FIG. 14C); (b) waste bag dispenser mounted/secured to the novel leash (FIG. 14D) preferably having a hole-based securing method/mechanism (FIG. 14E); (c) treat bags mounted/secured to the novel leash (FIG. 14F) preferably having a hole-based securing method/mechanism (FIG. 14G); and/or (d) airtag/tracker holders mounted/secured to the novel leash (FIG. 14H) preferably having an attachment method/mechanism (FIG. 14J).

In addition, the novel leash can support the use of uniquely designed communicative or decorative accessories, including both single-and double-sided elements, which can be secured to the leash/molded leash using various shaped openings, which can be, without limitation, holes. These accessories may serve aesthetic, branding, or behavioral signaling purposes. As non-limiting examples, the following 8 sample designs show how communication can be embedded in the leash through the following accessories, tags, communicative tags: (a) FIG. 14K—Friendly Dog (green background); (b) FIG. 14L—Red Stop sign with a hand icon and crossing line (e.g., “Do Not Pet”); (c) FIG. 14M—“I ♥ My Dog”; (d) FIG. 14N—“I ♥ My Human”; (e) FIG. 14P—Male symbol (dog is male); (f) FIG. 14Q—Female symbol (dog is female); (g) FIG. 14R—“Treats” symbol (dog enjoys treats); and (h) FIG. 14S—“Toys” symbol (dog enjoys playing or dog loves to play).

Accordingly, novel double-sided Accessory innovation is also disclosed herein and can include, without limitation, a novel double-sided decorative accessory system which can be preferably used with the disclosed molded leash invention, but can be also used with other leashes, as well as other items that are visible or easily visible from multiple sides. Unlike typical applications (e.g., backpacks, shoes, bags), leashes are one non-limiting example of being visible from both sides, which makes the novel double-sided accessory disclosed herein functionally and visually valuable.

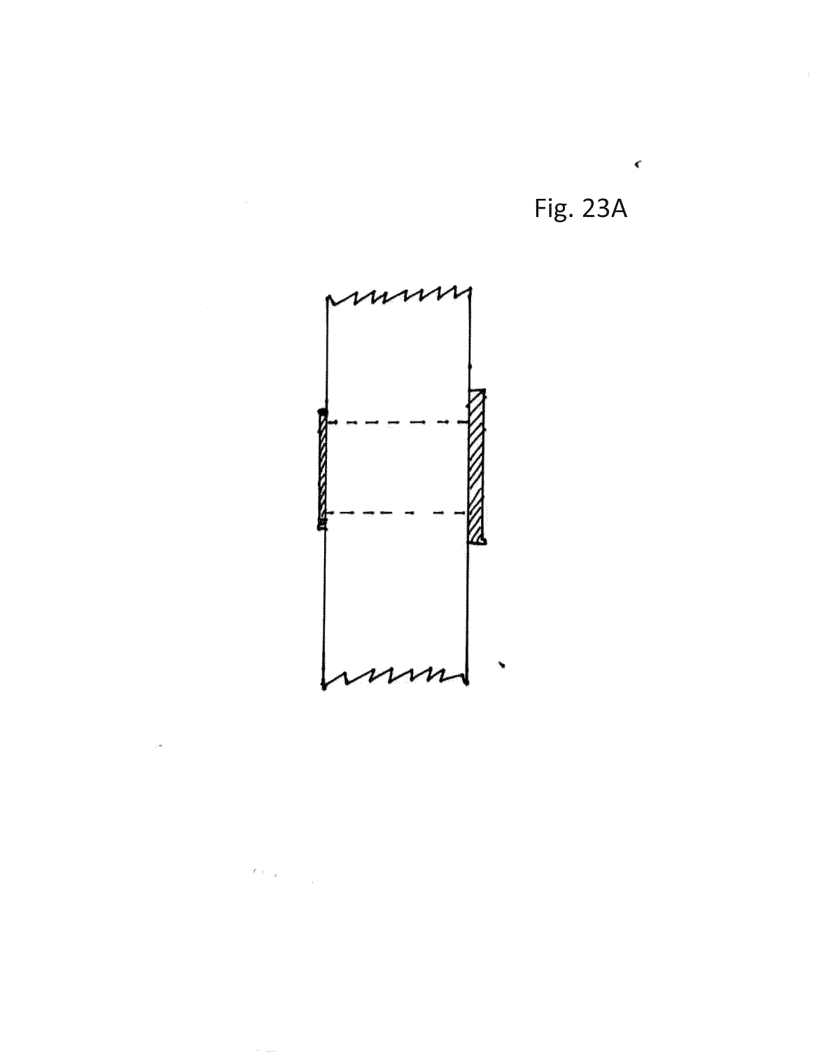

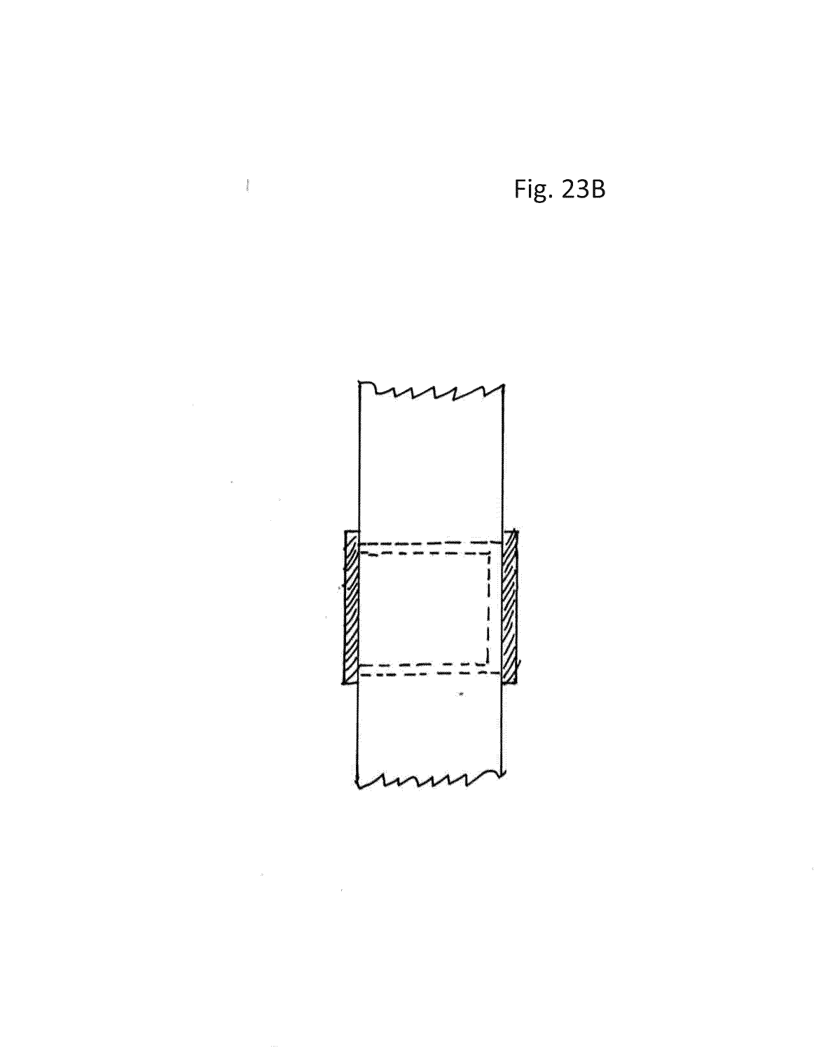

FIG. 23B shows one non-limiting embodiment for a double-sided accessory connection method, where the two decorative parts can connect through the leash body and secure via an interlocking or screw mechanism. This connection system can accommodate identical or different designs on each side, and with an adapter, can optionally be configured for single-sided use. The double-sided securing system can be primarily designed for use with holes but can also be adapted to other molded opening shapes, depending on the leash or other item design, and all are considered within the scope of the disclosure. Each double-sided accessory can be comprised of two connected parts, preferably joined through the molded opening of the novel leash or other item using a unique and secure attachment method.

The utility openings can be functionally integrated into the novel leash body, enabling modular, multi-purpose configurations that support practical add-ons, personalization, and communicative visibility.

The disclosed novel leash embodiments are not limited to animal use. Additional non-limiting applications for the novel leash can include: (a) child safety attachments (e.g., connecting to a child harness or backpack—See FIG. 15 or another item), (b) Preventing children from entering streets or falling from elevated areas (e.g., staircases, edges, ledges, cliffs, amusement park rides); (c) recreational or travel-related restraint applications.

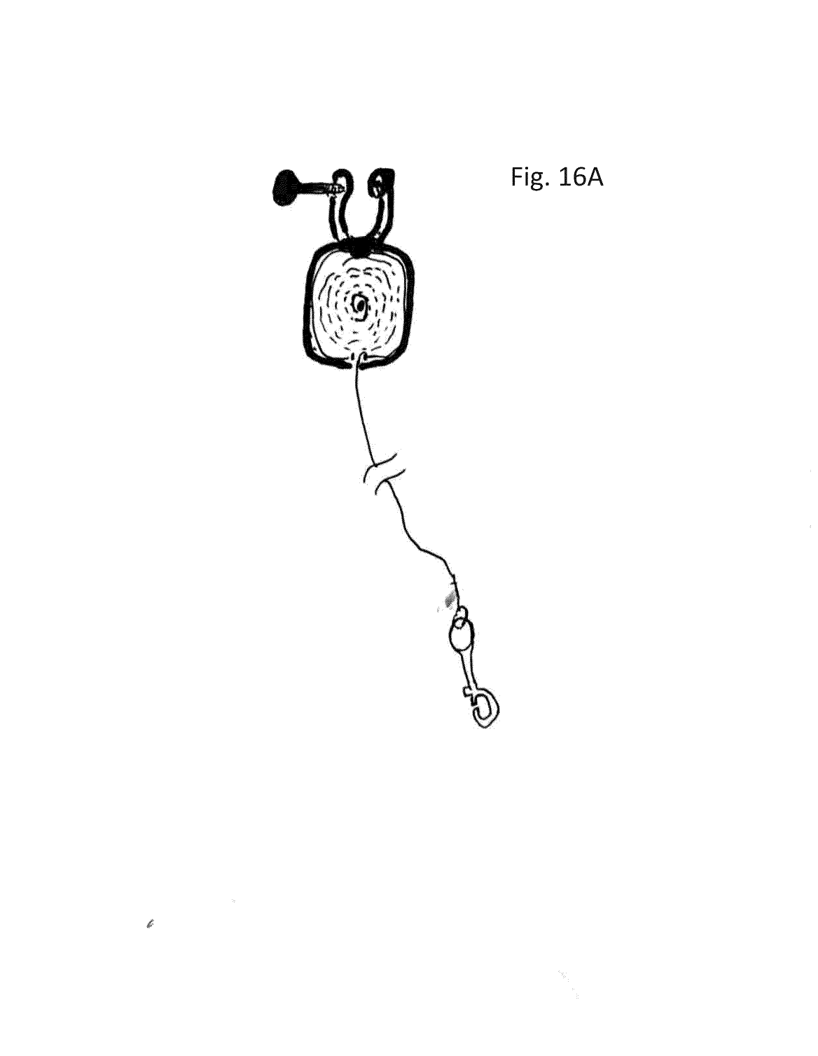

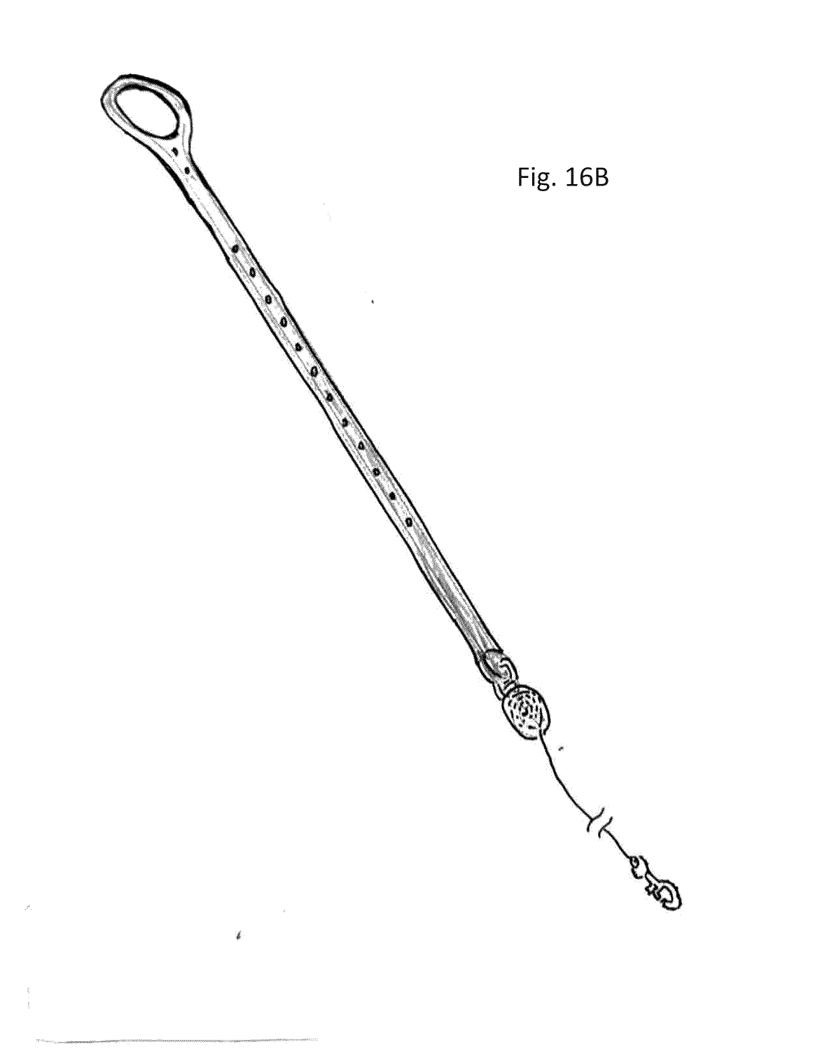

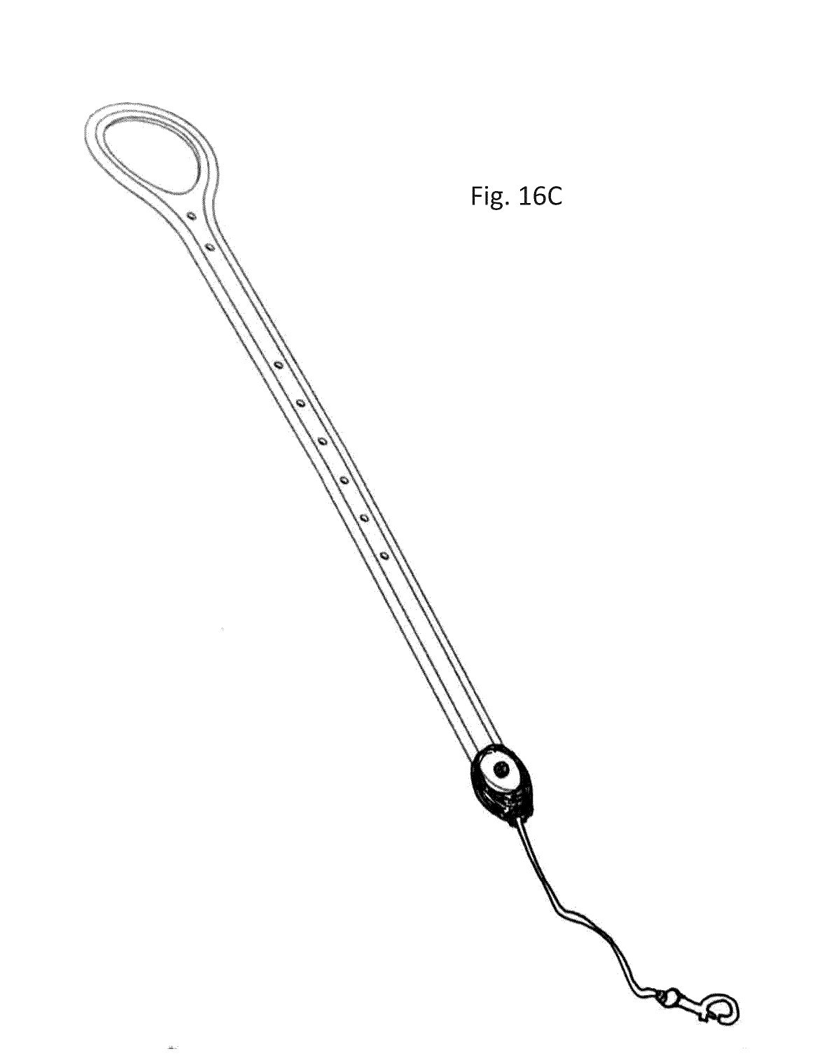

As seen in FIG. 16. an extension member can also be provided to provide extension capabilities for the novel leash. Non-limiting examples of extensions that can be used or incorporated, include, without limitation of the, one or more following (a) manufactured in various base lengths; (b) equipped with an extension system (FIG. 16A and FIG. B) having a durable cable, cord, wire, high-strength rope, tether, etc. (e.g. preferably being 10, 15, 25 ft or other dimension in length), (c) retractable or static extensions (FIG. 16B and FIG. 16C); and (d) extension may connect to the molded end (preferably non-handle end) via hooks, loops or other locking or securement mechanism now known or later developed).

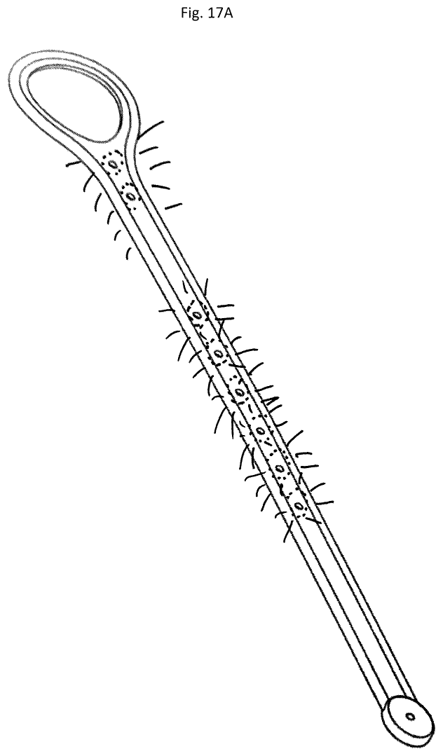

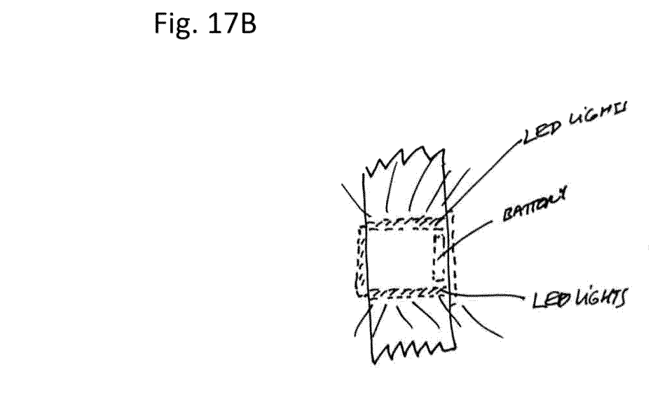

FIG. 17A and FIG. 17B illustrate a transparent embodiment for the novel leash which can be preferably provided with internal lightning. In this embodiment, the leash handle and/or elongated portion may be partially or fully constructed/manufactured from transparent or semi-clear materials, which can enable internal lighting to be visible. In one non-limiting embodiment, powered lights, such as, without limitation, LED modules can be installed in one or more of the holes/openings provided in the handle and/or elongated portion of the leash (FIG. 17A). The installed LED modules/lights emit light in a round pattern or other pattern and can preferably illuminate at least the interior edges of the holes. The same color lights or different color lights can be provided. Programmable lights (i.e. programmed on and off patterns for the lights) can also be provided. Thus, the light color(s) and effects/display patterns can vary, and all configurations are considered within the scope of the disclosure. FIG. 17B illustrates one non-limiting embodiment for securing the light to and/or through the holes.

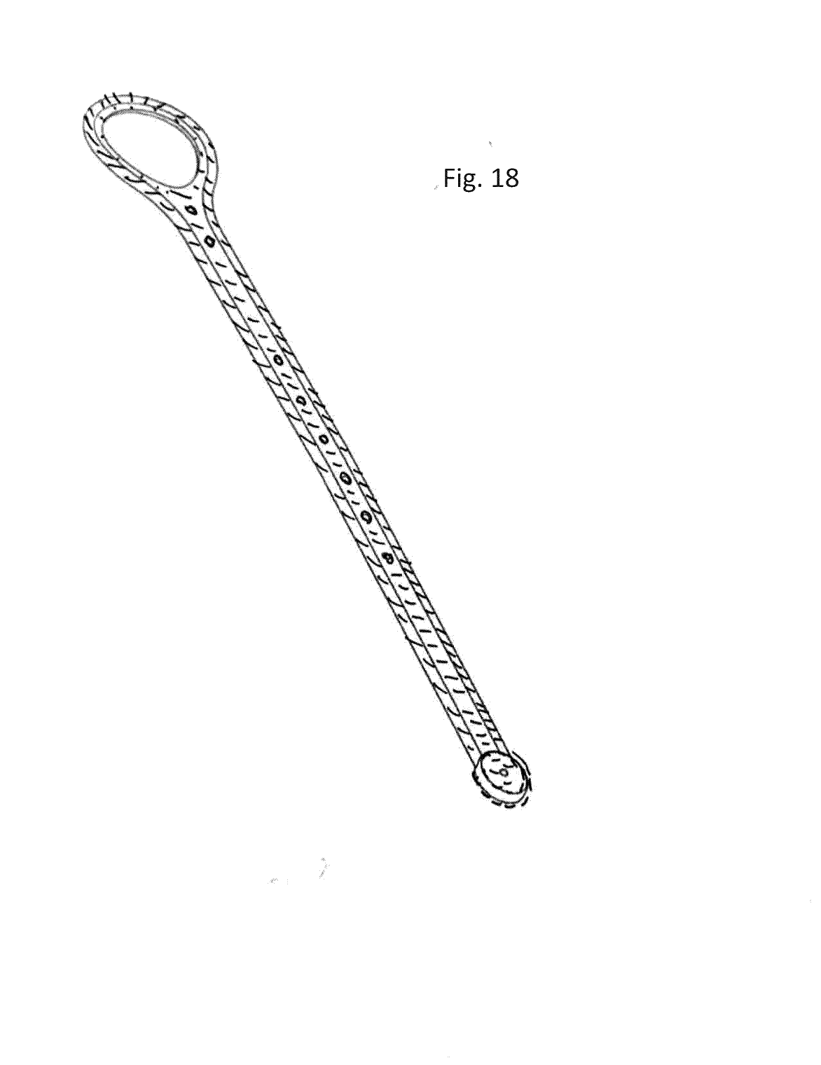

As seen in FIG. 18 the novel leash can be provided with at a partial or fully reflective and/or glow-in-the dark coating. Though a partial coating can be provided preferably where the reflective coating is applied such coating covers the full body of the leash. Without limitation, the reflective coating can: (a) enhance visibility during low-light or night use; and/or (b) react to ambient or direct light sources (e.g., headlights). A partial or full-body glow-in-the-dark (phosphorescent) coating can be applied and offers, without limitation: (a) passive visibility in total darkness; and/or (b) optional combination with reflective or transparent variants.

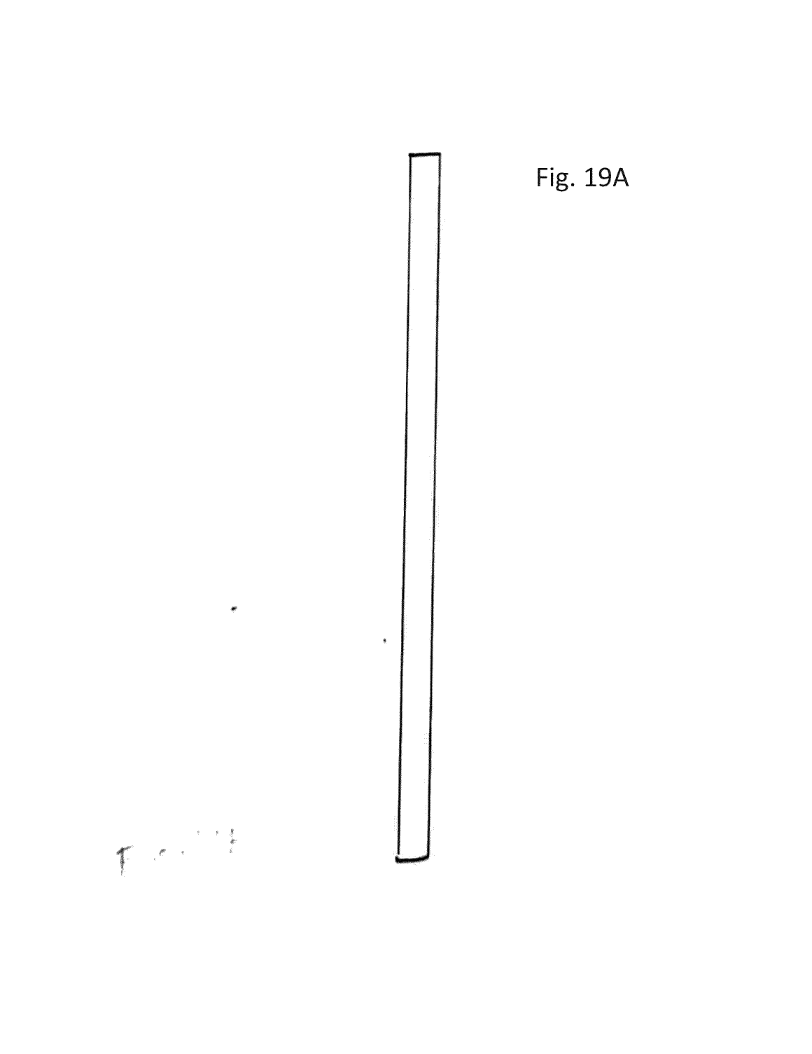

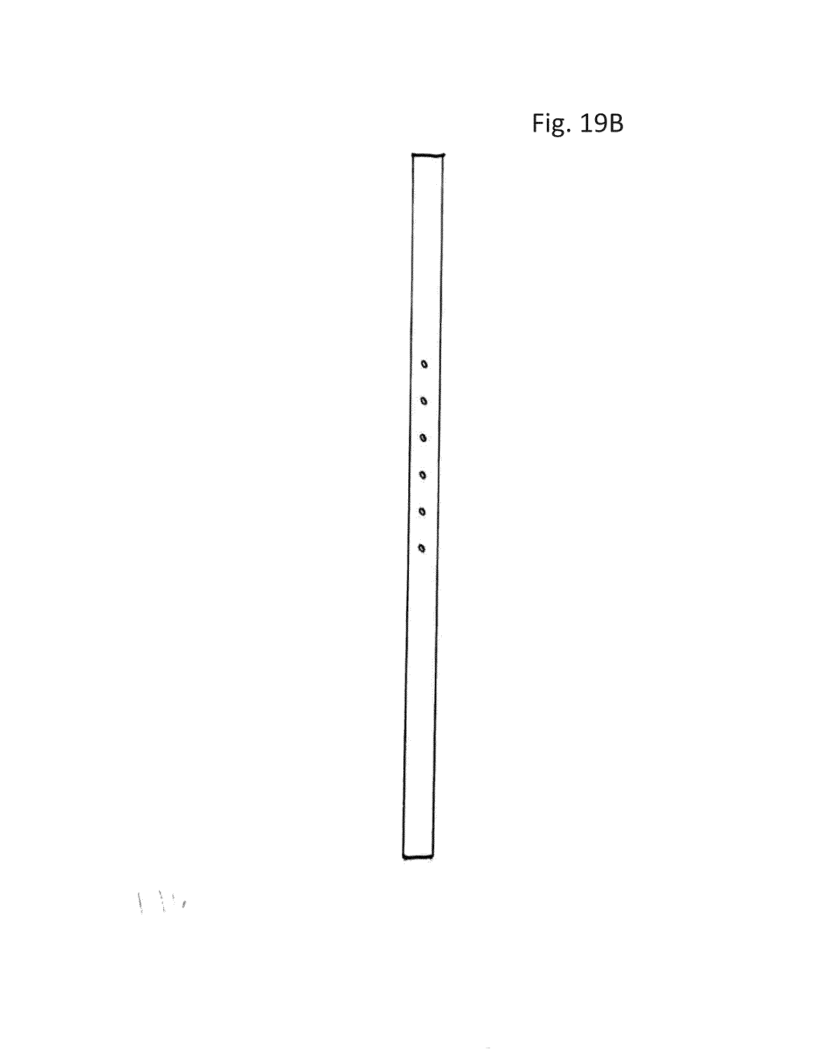

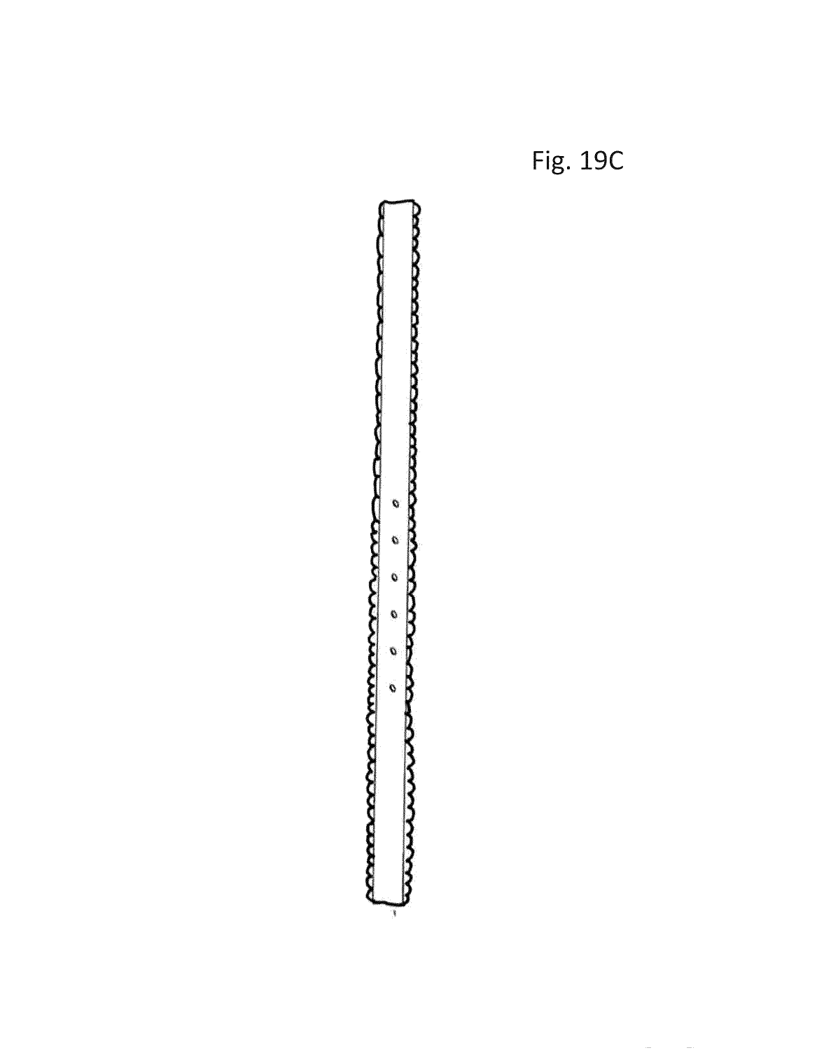

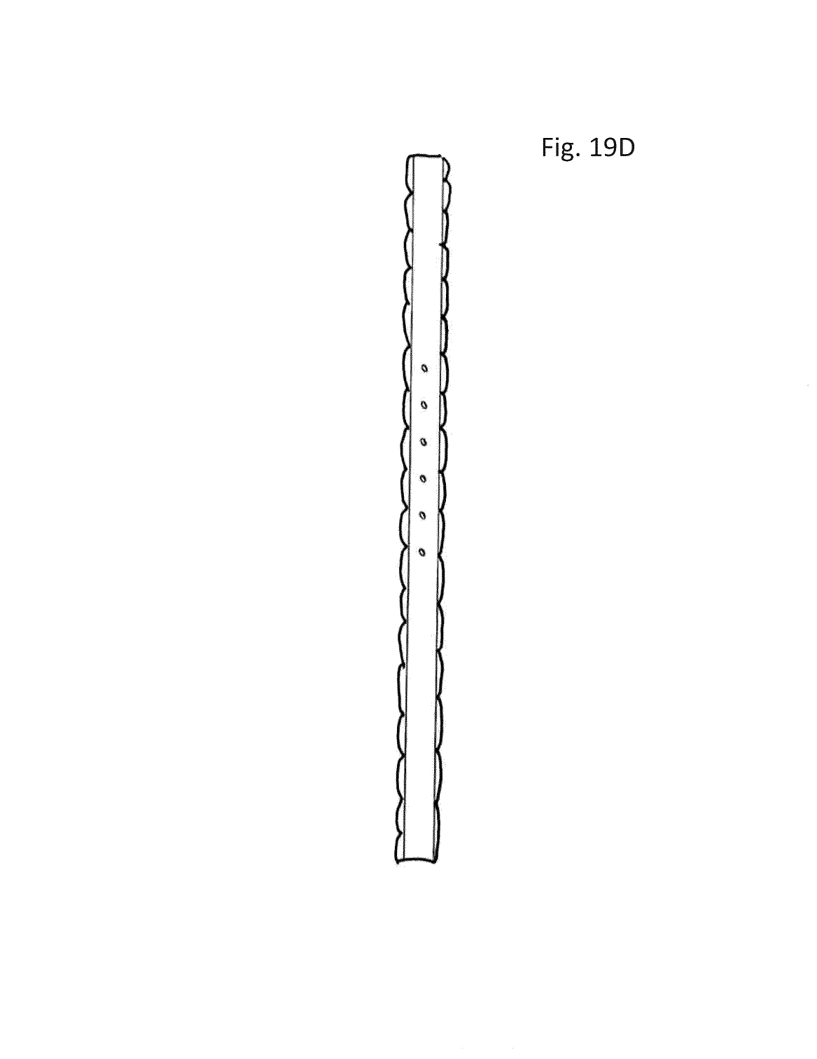

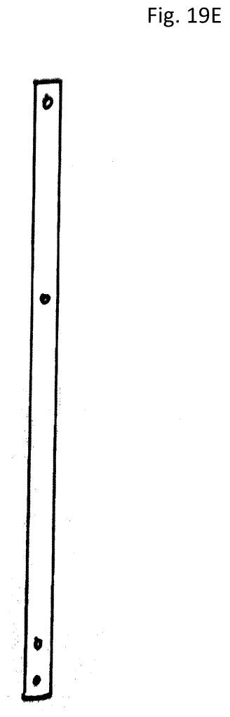

FIG. 19A through FIG. 19E illustrate various non-limiting mold/lease shapes that can be used for the novel leash embodiments, including leashes having integrated/monolithically formed handles and leashes having separately attached handles. Certain non-limiting molded shapes that the novel leash can be manufactured in include: (a) ergonomic curves or contours; (b) Decorative or functional elements; and/or (c) optional integrated or modular handles.

As seen in the non-limiting examples shown in the Figures, the leash strip (i.e. elongated member/portion) can be manufactured in various shapes/molded shapes, including, without limitation: (a) straight simple flat strip without holes (FIG. 19A); (b) straight flat strip with holes (preferably molded or punched holes) (FIG. 19B); and/or (c) ergonomic curves or contours (FIG. 19C and FIG. 19D), with or without holes. Other shapes, patterns, contours, openings, combinations thereof, etc. can also be used and are considered within the scope of the disclosure.

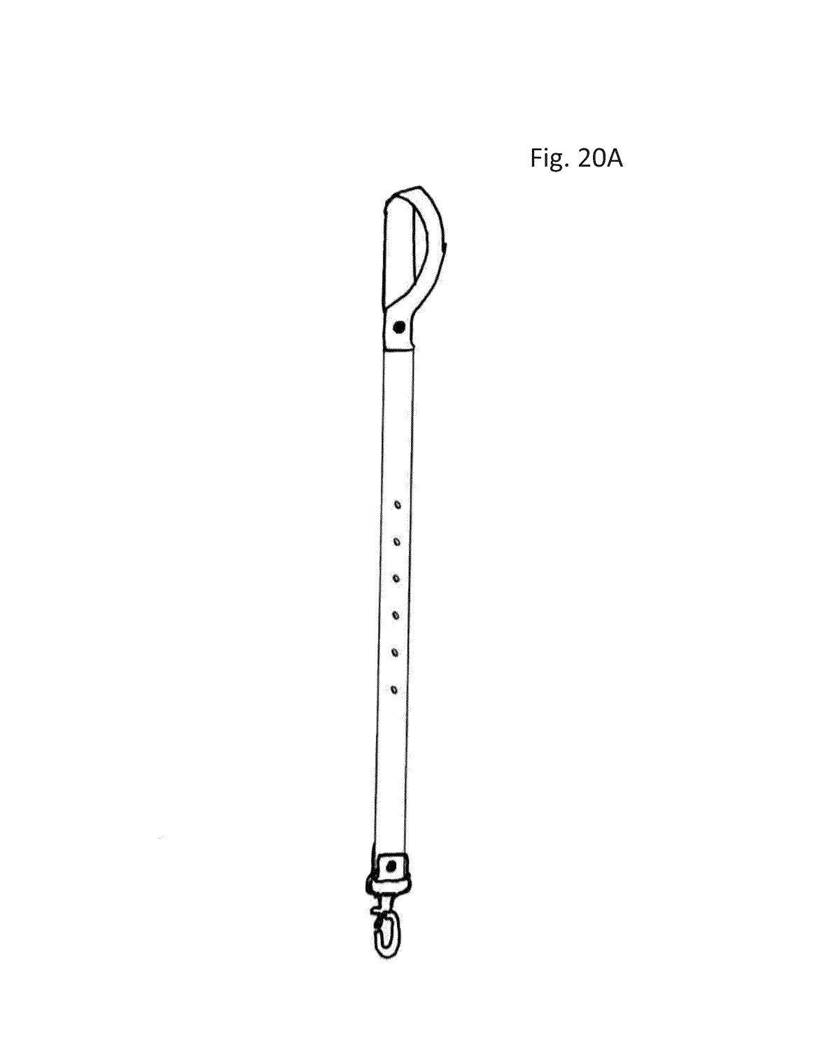

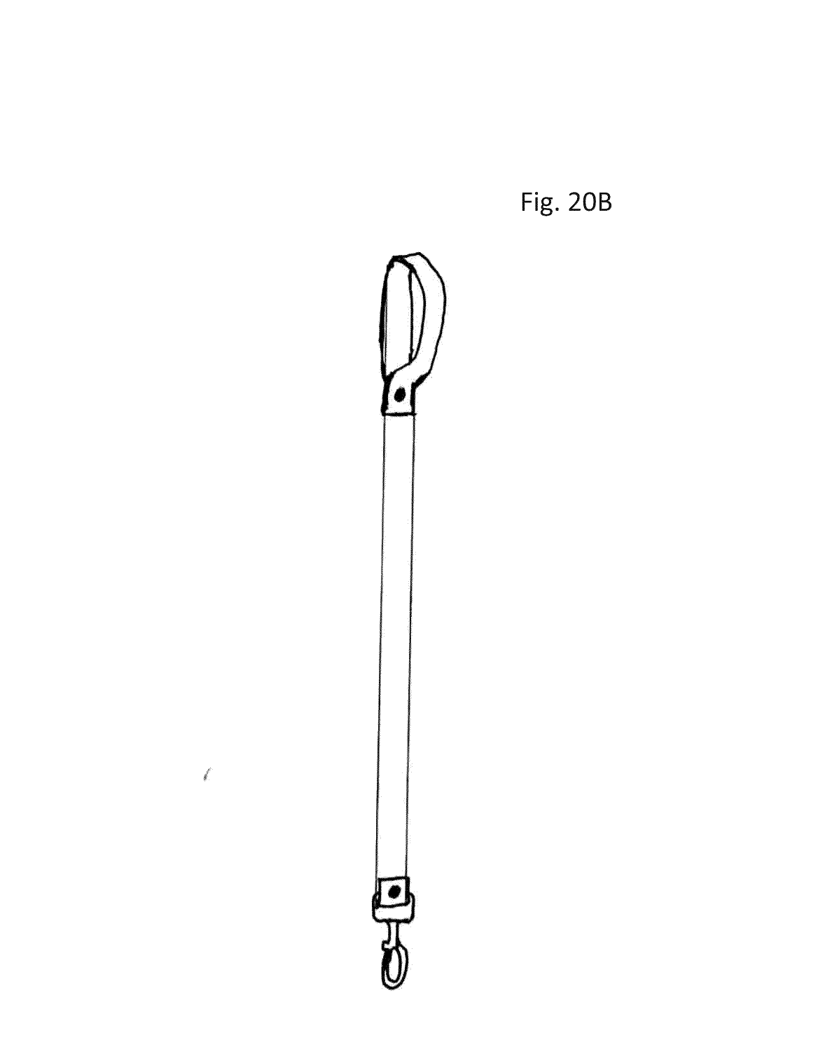

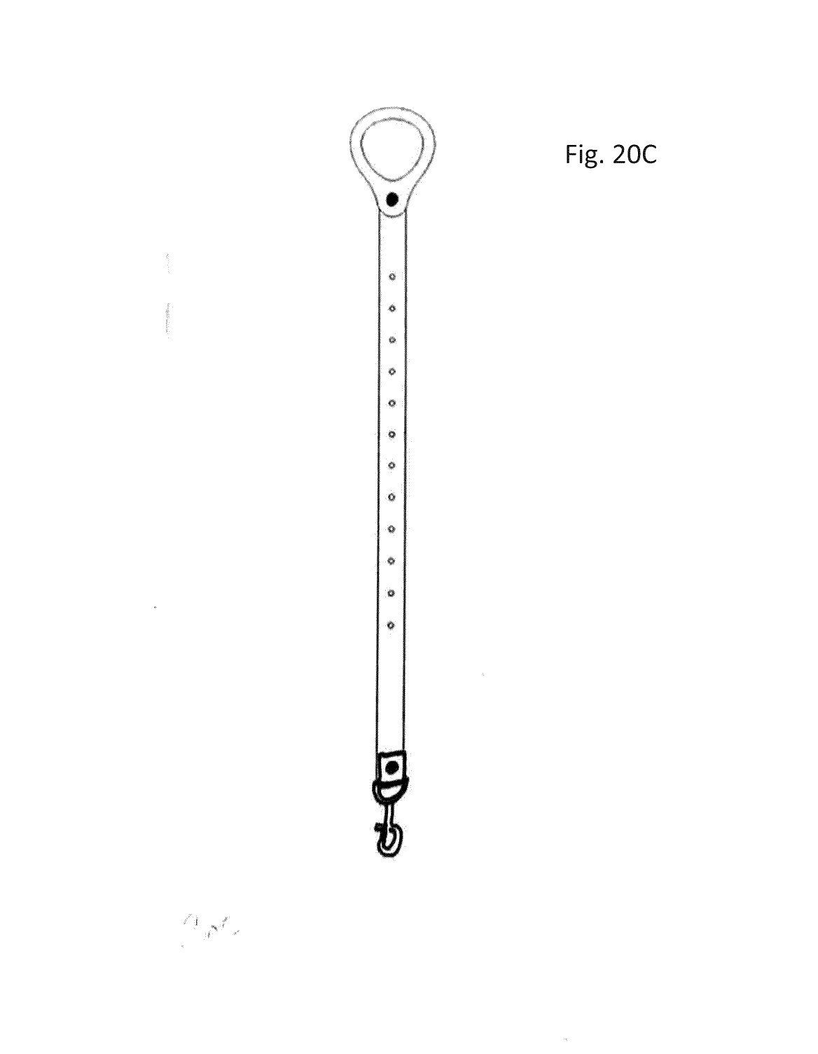

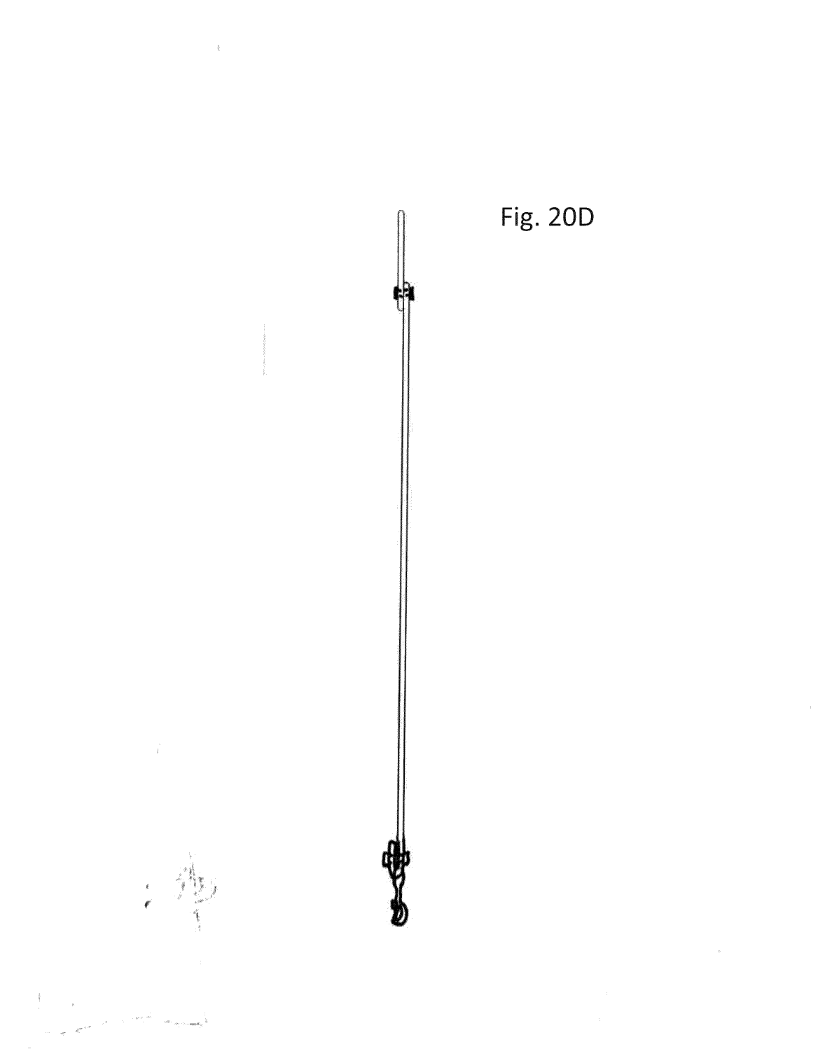

With respect to the use of integrated or modular handle with the strip/elongated portion, all molded leash strips (including, but not limited to, those shown or discussed above) can be used to form a handle and attach a swivel snap hook, such as, by using a folded-back section, as illustrated in FIG. 20A and FIG. 20B, discussed more below. The connection can be made by punching directly through the material with a metal rivet (but not limited to this method), without the need for pre-made holes. FIG. 19E shows two pre-made holes at or near one end (i.e. top portion of the elongated section/strip, preferably designed to form a handle from the leash strip), and two additional pre-made holes at or near the opposite end of the strip (i.e. bottom portion of the elongated section, preferably intended to secure a swivel snap hook and/or other fastener/connector). These pre-made holes allow for the use of plastic or metal screws, rivets, or other fastening methods. However, other securement fasteners can also be used and considered within the scope of the disclosure.

As mentioned above, the novel leash can include a handle and snap hook that can be connected at or to designated areas (i.e. ends) of the elongated portion. These areas can be reinforced and can include, without limitation: (a) formed by folding and securing the leash material via: (b) rivets (metal, steel, plastic or any other material used for rivets); (c) screws or molded connectors; and/or (d) alternative fasteners (now known or later developed) which can be used to reinforce sections and/or lock sections together (FIG. 20A and FIG. 20B). Thus, in the non-limiting embodiment seen in FIG. 20A & FIG. 20B, the novel leash can be provided with a folded-back leash end that can be secured with a rivet (i.e. without pre-made holes).

In a non-limiting embodiment, a separate handle/separately molded handle can be secured to the leash strip (FIG. 20C and FIG. 20D) preferably using similar or same securement methods, though other securement or fastening members can be used and are considered within the scope of the disclosure.

For the single-piece novel leash having the elongated portion with the leash integrated preferably at one end, the one-piece leash (i.e. handle and elongated portion) can be formed as one continuous molded/monolithically formed unit, which can allow for, without limitation: (a) greater strength; (b) reduced failure points; and/or (c) streamlined manufacturing.

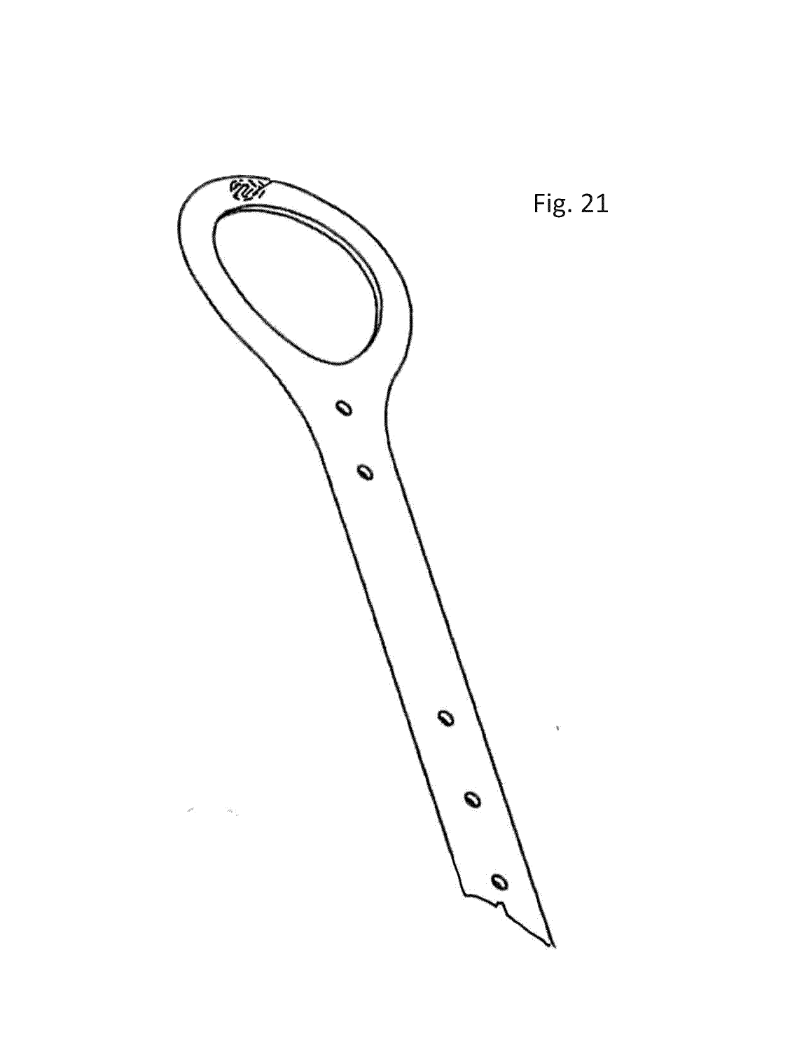

FIG. 21 illustrates the novel leash being provided with a non-fungible token (“NFT”) record, accessible via an embedded NFC chip preferably used, without limitation, for brand security and/or ownership verification. When provided, a pre-encoded NFC chip may be molded into the leash material or an associated handle, and can be used for, without limitation, one or more of the following: (a) authentication of the product's originality; (b) preventing counterfeiting; (c) linking to an ownership profile or pet identity; (d) emergency contact info storage.

Preferably, upon scanning, users can verify ownership, and lost animals can be returned via contact info in the NFT'-linked metadata stored or referenced by the NFC chip. The NFC chip can be a relatively small-size microchip that can be injected/inserted in the leash and/or harness. Thus, in FIG. 21 an embedded NFC chip can be placed in the novel molded leash material and linked to a corresponding NFT.

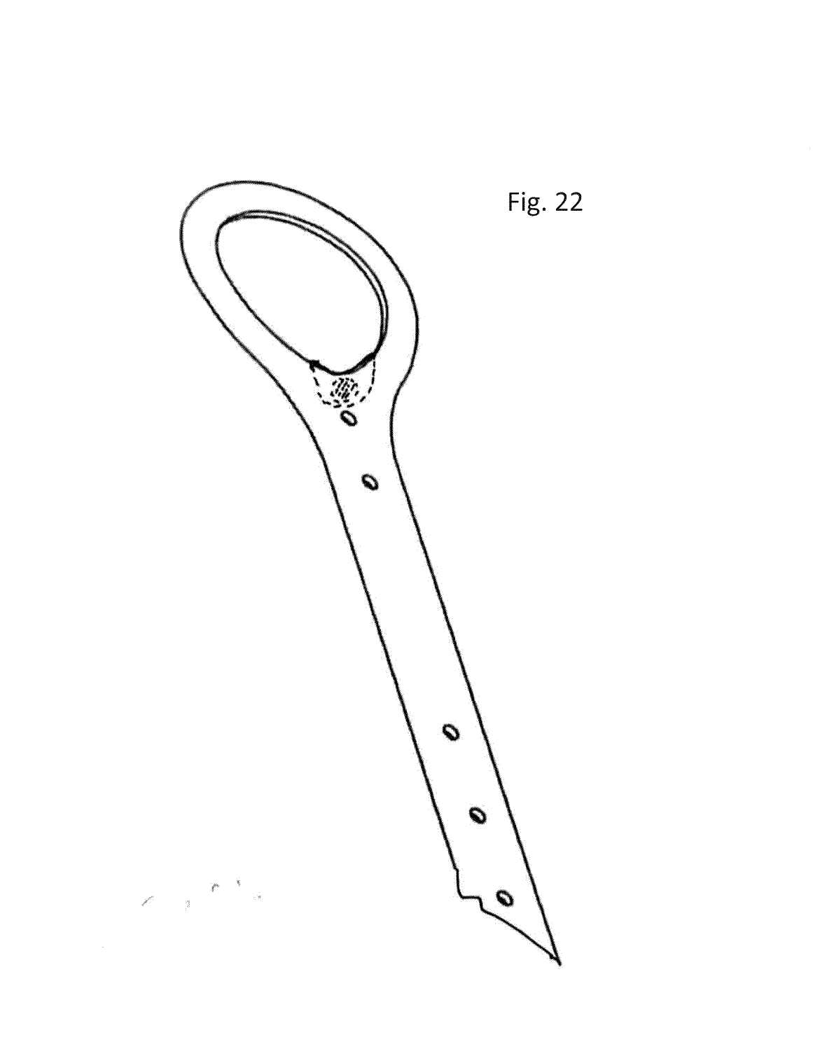

As seen FIG. 22 an embedded tracker pocket can also be provided and in one non-limiting embodiment can be a molded, built-in pocket (FIG. 22) or compartment for holding and/or storing, amongst other items, a passive ID tag or NFC chip lacing, embedded tracker and/or a GPS or Bluetooth tracker (e.g., AirTag, Tile, etc.), NFC chip/token, etc. The pocket may be integrated into the leash or a harness. The tracker, preferably provided in the pocket, can be used for location tracking of pets or children, though such is not considered limiting and other uses are also considered within the scope of the disclosure. Where a NFC chip is provided, the NFC chip can be relatively small or bigger in size and placed in the pocket and can be integrated with tracker devices.

The NFTs can be used to securely connect physical products to verifiable digital records, ensuring authenticity, ownership, and traceability. The NFT can be a cryptographically unique token, permanently recorded on a blockchain, and preferably cannot be modified once created. By assigning one NFT to one physical product, a tamper-resistant digital identity can be created for the leash that can confirm origin and provenance. This digital identity can be linked to a product (i.e. such as, without limitation, a leash or harness) using an embedded NFC (Near Field Communication) chip, which allows users to tap the product with a smartphone to access its NFT record on the blockchain to help protect against counterfeiting and to enhance consumer trust. When used with the leash and/or harness, the integration of embedded NFC communication chips can enable each uniquely manufactured product to be securely linked to a blockchain-based NFT, offering customers a way to verify authenticity, limited edition status, ownership history, and even brand-specific content via a simple phone tap. This feature can represent a technological enhancement to physical product authentication for the leash and/or harness in connection with secure, traceable, and digitally enhanced consumer gear or products.

FIG. 23A and FIG. 23B illustrate non-limiting embodiments for a novel securement system/mechanism for decorations and design elements/accessories on the novel leash/molded leash. The molded leash may be manufactured with variously shaped openings—including, but not limited to, round holes—to accommodate decorative, communicative, or branding elements and/or accessories. These openings can be an integral part of the leash structure and can be designed to support modular and user-friendly customization.

Two non-limiting examples for securing systems which can be used can include a single side decorative element attachment embodiment (FIG. 23A) and a double-sided decorative element (i.e. two separate decorative elements-one on each side of the novel leash) attachment (i.e. mechanical and/or snap-fit attachment) (FIG. 23B). are outlined below (though not limited to these methods):

For the single-sided decorative element embodiment, a decorative or communicative accessory can be inserted from one side of the leash (such as, without limitation, a larger, visible side), while the opposite side can feature a smaller backing or retention element. This rear backing can be preferably larger than the leash opening itself, so as to prevent the insert from traveling through the leash opening and dislodging.

For the double-sided decorative element embodiment, a decorative element can be visible from each side of the leash (i.e. taking advantage of the leash's dual-sided visibility-unlike common applications such as backpacks, bags or shoes, which typically require decoration on only one side). The two connected decorative parts can be secured through the molded opening/leash opening preferably using, without limitation, one of the following: (a) screw connection (e.g., male-to-female fastener, etc.); and/or (b) click-fit or twist-lock mechanism, where one side pushes into and locks with the other.

The two halves may display the same design or two different designs, and with an adapter, the system can also be configured for single-sided use. The two designs can be separate designs and/or can be related to each other. The disclosed, non-limiting double-sided securing system can be adapted to various opening geometries, offering broad flexibility in both form and function. The novel double-sided decorative element/item/accessory, etc. can allow a user to combine personal expression, safety communication, and branding visibility in a functional, secure format. With a novel adaptor connector, which can be compatible with the connection method used for the decorative element and/or based on a lock-in system mechanism and can be tailored to the dimensions of the leash opening, a double-sided accessory can be converted into a single-sided configuration and thus the converted double-sided accessory can be made adaptable into a single side decorative element and used on other items having single side visibility such as, without limitation, shoes, bags, clothing, etc. or any item capable of accommodating our single-sided securing system.

It should be understood that the exemplary embodiments described herein should be considered in a descriptive sense only and not for purposes of limitation. Where multiple embodiments are disclosed, descriptions of features or aspects within each embodiment should typically be considered as available for other similar features or aspects in other embodiments. While one or more embodiments may have been described with reference to the figure or figures, it is understood that various changes in form and details may be made therein without departing from their spirit and scope and such changes are considered within the scope of the disclosure.

All parts/components of the leash and their locations, attachment or securement mechanisms, dimensions, values, shapes, materials, number and shape of holes, etc. discussed above or shown in the figures, are merely by way of example and are not considered limiting and other part(s)/component(s) and their locations, attachment or securement mechanisms, dimensions, values, shapes, materials, number and shape of holes, etc. can be chosen and used and all are considered within the scope of the disclosure.

The benefits, advantages, solutions to problems, and any element(s) that may cause any benefit, advantage, or solution to occur or become more pronounced are not to be construed as a critical, required, or essential features or elements of any or all the future claims

While the novel leash has been described and disclosed in certain terms and has disclosed certain embodiments or modifications, persons skilled in the art who have acquainted themselves with the disclosure, will appreciate that it is not necessarily limited by such terms, nor to the specific embodiments and modification disclosed herein. Thus, a wide variety of alternatives, suggested by the teachings herein, can be practiced without departing from the spirit of the disclosure, and rights to such alternatives are particularly reserved and considered within the scope of the disclosure.

What is claimed is:

1. A leash, comprising:
an elongated member having a first end and a second end, wherein the first end adapted for receipt of a fastener or securement mechanism; and
a handle disposed at a second end of the elongated member.

2. The leash of claim 1 wherein the elongated member and the handle are constructed from a same material or same materials and are monolithically formed as a one-piece member.

3. The leash of claim 2 wherein the same material is EVA.

4. The leash of claim 1 wherein the elongated member having a plurality of holes extending along a portion of a length of the elongated member.

5. The leash of claim 1 wherein the elongated member having at least one opening at or near the first end adapted for attaching the fastener or securement mechanism to the elongated member at the first end.

6. The leash of claim 4 further comprising at least one decorative, functional or informational item adapted for securement to the elongated member at one of the plurality of holes.

7. The leash of claim 6 wherein the at least one decorative, functional or informational item containing information about an animal that the fastener or securement mechanism is connected to.

8. The leash of claim 6 wherein the elongated member having a first visible side and a second visible side and each hole of the plurality of holes extending through from the first visible side to the second visible side; wherein the at least one decorative, functional or informational item is a two-sided decorative item adapted for securement to the elongated member through at least one hole of the plurality of holes such that a first decorative element of the two-sided decorative item is positioned and associated with the first visible side of the elongated member and a second decorative element of the two-sided decorative item is positioned and associated with the second visible side of the elongated member.

9. The leash of claim 6 wherein the elongated member is constructed from a transparent or translucent material and wherein the at least one decorative, functional or informational items is a light item adapted to disperse visible light within the elongated member while the light item is turned on and secured to the elongated member.

10. The leash of claim 1 wherein the elongated member having an outer layer of reflective material or glow-in-the-dark material.

11. The leash of claim 1 wherein the first end of the elongated member also adapted for receipt of extension member.

12. The leash of claim 1 wherein the elongated member or the handle having a pocket adapted for receipt of a NFC chip.

13. A leash comprising:
a one-piece body comprising an elongated portion having at least one opening at or near a first end of the elongated portion and a handle portion monolithically formed with the elongated portion at a second end of the elongated portion, the elongated portion having a first visible side and a second visible side and defining a plurality of holes extending therethrough from the first visible side to the second visible side;
wherein the first end of the elongated portion is adapted for receipt of a fastener, securement mechanism or extension member attached at the at least opening at or near a first end of the elongated portion;
wherein the plurality of holes extends along a majority of a length of the elongated member as defined by a location of a first of the plurality of holes to a location of a last of the plurality of holes.

14. The leash of claim 13 wherein the one-piece body constructed from an EVA material.

15. The leash of claim 13 further comprising at least one decorative, functional or informational item adapted for securement to the elongated portion at one of the plurality of holes; wherein the information item containing information about an animal that the fastener or securement mechanism is connected to.

16. The leash of claim 13 wherein the elongated portion having a first visible side and a second visible side and each hole of the plurality of holes extending through from the first visible side to the second visible side; wherein the at least one decorative, functional or informational item is a two-sided decorative item adapted for securement to the elongated portion through at least one hole of the plurality of holes such that a first decorative element of the two-sided decorative item is positioned and associated with the first visible side of the elongated portion and a second decorative element of the two-sided decorative item is positioned and associated with the second visible side of the elongated portion.

17. The leash of claim 13 wherein the elongated portion is constructed from a transparent or translucent material and wherein the at least one decorative, functional or informational items is a light item adapted to disperse visible light within the elongated portion while the light item is turned on and secured to the elongated portion.

18. The leash of claim 13 wherein the elongated portion having an outer layer of reflective material or glow-in-the-dark material.

19. The leash of claim 13 wherein the elongated member or the handle having a pocket adapted for receipt of a NFC chip; wherein the pocket is monolithically formed with the elongated portion or handle portion.
